(19) United States
(12) Patent Application Publication
(10) Pub. No.: US 2025/0332583 A1
(43) Pub. Date: Oct. 30, 2025

(54) ELECTROCATALYSTS WITH TAILORED LOCAL CHEMICAL ENVIRONMENT

(71) Applicant: The Regents of the University of California, Oakland, CA (US)

(72) Inventors: Xiangfeng DUAN, Los Angeles, CA (US); Yu HUANG, Los Anglees, CA (US); Chengzhang WAN, Los Angeles, CA (US)

(73) Assignee: The Regents of the University of California, Oakland, CA (US)

(21) Appl. No.: 19/192,214

(22) Filed: Apr. 28, 2025

Related U.S. Application Data
(60) Provisional application No. 63/640,160, filed on Apr. 29, 2024.

(51) Int. Cl. B01J 35/50; B01J 23/89; B01J 33/00; B01J 35/64; B01J 35/80

(52) U.S. Cl. CPC B01J 35/505; B01J 23/892; B01J 33/00; B01J 35/64; B01J 35/80

(57) ABSTRACT

The present embodiments relate generally to electrochemical processes and more particularly to methods and apparatuses for high-performance alkaline water electrolysis and renewable fuel generation. One or more embodiments relate to a unique core-shell structure (A@BOxHy) in which the amorphous or nanoporous shell structure (BOxHy) can significantly enhance reaction kinetics and allow selective transport of certain feedstock while protecting the core catalysts (A) from competitive adsorption and morphology degradation, leading to both optimized activity and durability.

### CROSS-REFERENCE TO RELATED APPLICATIONS

The present application claims priority to U.S. Provisional Patent Application No. 63/640,160 filed Apr. 29, 2024, the contents of which are incorporated herein by reference in their entirety.

### STATEMENT OF GOVERNMENT SPONSORED RESEARCH

This invention was made with government support under N00014-18-1-2155 awarded by the U.S. Navy, Office of Naval Research, and 1800580 awarded by the National Science Foundation. The government has certain rights in the invention.

### TECHNICAL FIELD

The present embodiments relate generally to electrochemical processes and more particularly to methods and apparatuses for applications such as high-performance alkaline water electrolysis and renewable fuel generation.

### BACKGROUND

Electrochemical processes play a central role in clean energy generation, storage, and utilization, and can help dramatically reduce fossil fuel combustion to enable a sustainable future. For example, electrocatalytic hydrogen evolution reaction (HER), oxygen evolution reaction (OER), Nitrogen reduction reaction (NRR) and CO₂ reduction reaction (CO₂RR) are central for renewable chemical fuel production; while the hydrogen oxidation reaction (HOR), methanol oxidation reaction (MOR), hydrazine oxidation (HzOR) and oxygen reduction reaction (ORR) are essential for fuel cell technologies to directly convert chemical energy into electricity. The efficiency of these processes relies critically on the surface-active site of the electrocatalysts that can facilitate charge transfer and chemical transformation at the electrode (or electrocatalyst)-electrolyte interface (EEI). Considerable efforts have been devoted to tailoring the atomic configuration and electronic structure of the surface-active sites to obtain the optimum electroactivity. Beyond the active sites, the local chemical species can compete for adsorption on active sites, inactivate (poison) the active sites, and/or profoundly affect the mass transfer of feedstock/products. An efficient electrochemical reaction requires a concerted supply of reactants and the removal of products under specific operating conditions to achieve high activity and a long lifetime. To this end, a comprehensive approach that integrates electrocatalytic active site design with strategies to manipulate local pH, nanoscale mass/charge transport, ion separations, or structural evolution is needed for designing high-performing electrocatalysts that can facilitate efficient chemical transformations and electron transfer under complex electrolyte conditions.

It is against this technological backdrop that a technological solution to these and other problems rooted in this technology was sought.

### SUMMARY

The present embodiments relate generally to electrochemical processes and more particularly to methods and apparatuses for high-performance alkaline water electrolysis and renewable fuel generation. One or more embodiments relate to a unique core-shell structure (A@BOₓH_{y}) in which the amorphous or nanoporous shell structure (BOₓH_{y}) can significantly enhance reaction kinetics and allow selective transport of certain feedstock while protecting the core catalysts from competitive adsorption and morphology degradation, leading to both optimized activity and durability. For example, with an amorphous hydrated (e.g. Fe, Co, Ni, Ru, Rh, Si, etc.) oxides/hydroxides shell and a precious metal core, the proton can effectively diffuse through the shell to achieve the core catalyst via the Grotthuss mechanism with a very low energy barrier, while other cations or anions are prohibited to penetrate the shell due to size effect, resulting in exceptional tolerance to poisoning species. In the meantime, the shell can also serve as the promoter that reduces the activation energy barrier of certain rate-determining steps, such as the Volmer step in the HER and HOR, and the OH desorption step in the ORR, leading to significantly enhanced activity. More importantly, by tuning the composition and structure of the shell (e.g. NiOₓH_{y} to NiOₓ₋₁SH_{y}), one can effectively tune the hydrogen transport rate through the shell and thus tailor the local equilibrium pH at the surface of the core catalysts, leading to the desired proton concentration for pH-sensitive reactions such as CO₂ RR or NRR.

As a successful demonstration of this concept, developed was a unique “Ni(OH)₂-clothed bare-foot Pt-tetrapod” core/shell nanostructure [Ptₜₑₜ@Ni(OH)₂] that has improved alkaline HER activity/durability and presents an attractive catalyst material for anion exchange membrane (AEM) water electrolyzers and renewable chemical fuel generation. An example Ptₜₑₜ@Ni(OH)₂ consists of a Pt nano-tetrapod (Ptₜₑₜ) core as the HER catalyst and an amorphous Ni(OH)₂ shell as the water dissociation (WD) catalyst and proton permselective encapsulation. In particular, the hydrogen-bond framework in the amorphous Ni(OH)₂ layer stabilizes the intermediate state of the WD step and facilitates water dissociation into OH⁻ and H⁺, with OH⁻ diffusing into the alkaline electrolyte and the H⁺ efficiently transporting to the Pt surface through the amorphous Ni(OH)₂ matrix following a barrierless cascade pathway (Grotthuss-like mechanism). Additionally, the encapsulation by the proton permselective Ni(OH)₂ efficiently rejects water impurity ions (e.g., Cl⁻ and I⁻) and suppresses Pt atom leaching, leading to significantly enhanced tolerance to water impurities, long-term operation durability, and overall catalyst lifetime.

Examples of how the present embodiments address an unmet need in the market:

1) Record high activity for Pt cost-reduction on the cathode: With greatly improved HER kinetics from the selective enrichment of proton by the Ni(OH)₂ proton sieve, the Ptₜₑₜ@Ni(OH)₂ coreshell catalysts show a record-high specific activity (SA) of 27.7 mA/cm² Pt at −70 mV vs. RHE at pH 14, which is 28 times higher than that of Pt/C, respectively; and considerably higher than the previous state-of-art (14.8 mA/cm² Pt@ −70 mV vs. RHE). Further, such a high SA observed in Ptₜₑₜ@Ni(OH)₂ has also directly led to a record-high MA of 13.4 A/mgPt @ −70 mV vs. RHE, which is 18-fold higher than that of the commercial Pt/C and represents the best among the state-of-the-art Pt-based HER catalysts in the alkaline electrolyte. This brings a great potential to significantly reduced the Pt loading in the AEM water electrolyzers, leading to the commercialization of cost-effective low-Pt AEM water splitting.

2) Stability enhancement for long-lifetime operation: The electrolyzers usually need stable operation over 6000 hours, which requires highly-durable catalysts. However, the commercial Pt/C and other reported Pt catalysts cannot meet the requirement because their exposed Pt surface sites could undergo severe Oswald ripening during HER and rapidly lose the designed nanostructure and the original activity. The exceptionally stable catalytic activity observed in Ptₜₑₜ@Ni(OH)₂ can be attributed to the encapsulation Ni(OH)₂ proton permselective sieve that effectively retards the nanocatalyst Oswald ripening process by preventing surface Pt sites from leaching off, diffusing away during the long-term HER process to ensure extraordinary structural stability and activity durability. This provides the potential solution for developing AEM water electrolyzers with a longer lifetime.

3) Impurity tolerance for reduced ultrapure-water capital cost: One of the requirements of PEM/AEM water electrolysis is the ultrapure water feeding with a minimum requirement of American Society for Testing and Materials (ASTM) Type II deionized (DI) water (resistivity >1 MΩ cm) while ASTM Type I DI water (>10 MΩ cm) is preferred. Therefore, the ultrapure water system brings extra costs that occupy around 13% of the total capital costs of the electrolyzers. It is indeed economically beneficial if the catalysts can retain high activity in regular water. However, the commercialized Pt and other reported Pt catalysts without such a protection layer significantly lose the activity in the electrolyte with impurities such as halide anions. For the present Ptₜₑₜ@Ni(OH)₂ catalysts, the proton permselective Ni(OH)₂ sieve could help isolate the active Pt sites from the bulk electrolyte environment and thus improve the catalytic tolerance to water impurities with competitive adsorption or capability of etching. Such an exceptional tolerance to ionic impurities could help relax the water purity requirements in practical water electrolysis, which is a largely unaddressed cost matter.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 illustrates example aspects of a “Ni(OH)₂-clothed Pt-tetrapod” core-shell structure according to embodiments.

FIGS. 2A to 2D illustrate example structural characterizations of Ptₜₑₜ@Ni(OH)₂ nanocatalysts according to embodiments.

FIGS. 3A to 3F illustrate aspects of example electrochemical characterizations of Ptₜₑₜ@Ni(OH)₂ nanocatalysts according to embodiments.

FIGS. 4A to 4C illustrate example aspects of water dissociation (WD) performance of Pt/Ni(OH)₂ according to embodiments.

FIGS. 5A to 5H illustrates example evaluations of HER activity and stability of Ptₜₑₜ@Ni(OH)₂ according to embodiments.

FIG. 6 is a graph illustrating an example comparison of Pt/C HER activity in acid and base. There is a 142 mV difference between the activity of Pt/C (5.1 gPt/cm²) in acid and base at a current density of 10 mA/cm². In a real application, the current is always on the scale of 500 mA/cm²−1000 mA/cm², and the Tafel slopes in the acidic case and basic case are 29.6 mV/dec and 118.4 mV/dec respectively. Thus this potential difference will be significantly amplified at higher current density in the real application. Moreover, at −20 mV vs. RHE, the activity under pH 0 is about 89.5 times higher than that under pH 14, almost two orders of magnitude. For the same reason, the activity difference will also be amplified in the real application and will potentially be enlarged to 2-3 orders of magnitude, or even bigger.

FIG. 7 illustrates example aspects of Pt NPs decorated with crystalline Ni species as recognized by the present disclosure. The decoration of a Pt surface with crystalline NiOₓ or NiSₓ species can partly facilitate water dissociation and activate nearby Pt for improved HER activity, but with two potential limitations that could compromise the overall activity: (i) Pt atoms buried under the crystalline NiOₓ are not accessible to the electrolyte and hence cannot participate in the surface reaction; (ii) only the Pt sites in close proximity to the Ni sites can benefit from the enhanced water dissociation kinetics. The diffusion length of the generated H⁺ is estimated to be −1 nm in the alkaline electrolyte and cannot benefit Pt sites farther away from the Ni species can further migrate on the Pt surface to neighboring Pt sites, the adsorbed H will be consumed immediately once being adsorbed due to the much faster Tafel step than the Volmer step during HER, and thus has a low possibility to spill over. Therefore despite partly enhanced kinetics, the majority of Pt sites are exposed to alkaline electrolyte and the HER and follow a typical Volmer- or Heyrovsky-step limited pathway with Tafel slopes of 40 mV/dec or larger. Moreover, the exposed Pt surface sites will undergo severe Oswald ripening during HER and gradually lose the designed nanostructure and the original activity.

FIG. 8 is a graph illustrating an example SEM-EDS analysis of Ptₜₑₜ@Ni(OH)₂. The SEM-EDS result of the Ptₜₑₜ@Ni(OH)₂ shows the Pt:Ni atomic ratio is around 1:2.3.

FIGS. 9A to 9C illustrate aspects of an example Pt tetrapod core according to embodiments: FIG. 9A is a low-resolution STEM image of Pt tetrapods remained after completely removing the Ni(OH)₂ shell in acidic condition. FIG. 9B is a HAADF-STEM image of a Pt tetrapod. The Pt core has a unique tetrahedral structure with four Pt pods grown along the <111> directions. FIG. 9C is a graph illustrating the CV of Ptₜₑₜ@Ni(OH)₂ and Pt tetrapods. The redox peaks at 1.39 V vs. RHE in the anodic scan and 1.28 V vs. RHE in the cathodic scan represent the redox process of Ni₃+/Ni₂+ on the surface Ptₜₑₜ@Ni(OH)₂, while disappearing after in pure Ptₜₑₜ, indicating complete removal of the Ni(OH)₂ shell.

FIGS. 10A and 10B are images illustrating an example High-resolution TEM characterization of Ptₜₑₜ@Ni(OH)₂ according to embodiments: FIG. 10A provides TEM images and FFT pattern of Ptₜₑₜ@Ni(OH)₂. Only the FFT pattern of Pt core can be observed and there is no FFT pattern of Ni(OH)₂, indicating the amorphous feature of Ni(OH)₂ shell. FIG. 10B provides representative HAADF-STEM images of Ptₜₑₜ@Ni(OH)₂. It can be overserved that the crystalline core is covered by a blurry amorphous shell.

FIGS. 11A to 11C are graphs illustrating an example XPS and XRD characterization of Ptₜₑₜ@Ni(OH)₂ according to embodiments: FIG. 11A is a graph illustrating the Pt 4f XPS spectra of Ptₜₑₜ@Ni(OH)₂. Two main peaks at around 74.4 (Pt 4f5/2) and 71.1 eV (Pt 4f7/2) indicate that most of the Pt atoms are in the metallic phase. FIG. 11B is a graph illustrating the Ni 2p XPS spectra of Ptₜₑₜ@Ni(OH)₂. The two main peaks at 856.1 eV and 873.7 eV belong to the Ni(OH)₂ 2p3/2 and Ni(OH)₂ 2p1/2 orbitals respectively, and the characteristic spin-energy separation of 17.6 eV between Ni(OH)₂ 2p3/2 and Ni(OH)₂ 2p1/2 is also consistent with other literature, delivering a clear result of Ni(OH)₂ dominated shell composition. The singlet feature of the Ni(OH)₂ 2p1/2 also strengthens the conclusion of Ni(OH)₂ as the main composition in the shell since the NiO 2p1/2 peak possesses a doublet peak feature. FIG. 11C is a graph illustrating the XRD pattern of Ptₜₑₜ@Ni(OH)₂. Only symmetric peaks were found at 40.7° the XRD pattern of Ptₜₑₜ@Ni(OH)₂, which was assigned to the Pt-rich tetrapod skeleton. No Ni(OH)₂ peak was observed at around 37°.

FIG. 12 is a graph illustrating an example Ni K-edge XANES experimental spectra of Ptₜₑₜ@Ni(OH)₂ along with reference materials. The oxidation state of Ni in Ptₜₑₜ@Ni(OH)₂ is slightly lower than the standard Ni(OH)₂, indicating the charge transfer at the interface from Pt to Ni.

FIGS. 13A and 13B are graphs illustrating example XAS results of Pt L3 edge: FIG. 13A provides the Pt L3-edge XANES experimental spectra. The Pt of Ptₜₑₜ@Ni(OH)₂ has a slightly higher oxidation state than the standard Pt foil, indicating the charge transfer from Pt to Ni at the interface, consistent with the Ni XANES spectra result. Note that the XAS signal is an average of all the targeted atoms, thus the change of XANES intensity resulting from the charge transfer between the interfacial atoms is diluted by the bulk signal from non-interfacial atoms, and thus is always not very obvious. FIG. 13B provides Fourier transform magnitudes of the Pt L3-edge EXAFS experimental signal of Ptₜₑₜ@Ni(OH)₂ along with reference materials.

FIG. 14 illustrates an example WT EXAFS signal of Pt and Pt foil. The negative shift of the maxima in the K space from Ptₜₑₜ@Ni(OH)₂ to Pt foil reveals that the Pt is coordinated with a lighter transition metal, which should be Ni in the present example.

FIGS. 15A to 15L are graphs illustrating an example Fourier-transformed magnitude of Ni K-edge EXAFS and Pt L-edge spectra in k and R space. FIGS. 15A and 15B are for Ni foil, FIGS. 15C and 15D are for Ni(OH)₂, and FIGS. 15E and 15F are for Ni K-edge Ptₜₑₜ@Ni(OH)₂. FIGS. 15G and 15H are for Pt foil. FIGS. 15I and 15J are for PtO₂ and FIGS. 15K and 15L are for Pt L-edge Ptₜₑₜ@Ni(OH)₂. Measured and calculated spectra are well matched for all samples. The best-fit parameters are shown in Tables 2 and 3.

FIGS. 16A to 16C are graphs illustrating an example Kinetics comparison of Ptₜₑₜ@Ni(OH)₂ and Pt/C. FIG. 16A is a LSV curve of Pt/C at pH 0-2 and 14, and Ptₜₑₜ@Ni(OH)₂ at pH 14. The specific activity of Ptₜₑₜ@Ni(OH)₂ in pH 14 lies in between that of Pt/C in pH 1 and 3, indicating that the H⁺ supply rate to the Pt core of Ptₜₑₜ@Ni(OH)₂ is close to the Pt/C in the pH 1-3. More specifically, its initial activity near the 0 V vs. RHE is slightly worse than that of pH 2, but it rapidly surpasses the pH 2 curve after 0.02 V vs. RHE, indicating that the overall H⁺ supply rate at the high current level is even better than typical Pt/C under pH 2 and very close to pH 1. FIGS. 16B and 16C provide results of, Tafel slope analysis of Pt/C at pH 0-3 and 14, and Ptₜₑₜ@Ni(OH)₂ at pH 14, respectively. The Tafel analysis shows that the Tafel slope of Ptₜₑₜ@Ni(OH)₂ is 25 mV/dec, higher than the 36 mV/dec of pH 2 and comparable to the 29 mV/dec of pH 1, indicating the HER kinetics of Ptₜₑₜ@Ni(OH)₂ is comparable to the Pt in pH 1. This further confirms the finding that the Ni(OH)₂ shell can provide an acidic-like hydrogen supply rate, although not at the level of pH 0.

FIGS. 17A and 17B are graphs illustrating an example Cl⁻ and I⁻ tolerance of Ptₜₑₜ and Ptₜₑₜ@Ni(OH)₂ according to embodiments. FIG. 17A illustrates 0.5 M Cl⁻ and FIG. 17B illustrates 0.25 M I⁻, the pure Ptₜₑₜ has a significant activity drop, while there is no obvious change of Ptₜₑₜ@Ni(OH)₂ HER activity.

FIG. 18 is a graph illustrating an example stability test of Ptₜₑₜ@Ni(OH)₂ with a loading of 5.6, 33.6, 67.2 and 100.8 μgPt/cm². There is an obvious stability enhancement as loading increases.

FIGS. 19A to 19D are example STEM image and EDS mappings of Ptₜₑₜ@Ni(OH)₂, Pt, Ni and Pt+Ni, respectively, according to embodiments after stability tests. Both the structure and elements distribution are well maintained after the stability test.

FIGS. 20A to 20C are graphs illustrating an example HER Stability test of Ptₜₑₜ@Ni(OH)₂ according to embodiments with periodic interval surface cleaning. FIG. 20A illustrates chronopotentiometry stability tests of Ptₜₑₜ@Ni(OH)₂, Ptₜₑₜ and Pt/C with periodic surface cleaning. A 30-cycle CV from 0.05 to 1.1 V vs. RHE was performed in between two stability tests to clean the surface. FIG. 20B illustrates an Irreversible overpotential increase of Ptₜₑₜ and Pt/C after periodic surface cleaning. The activity of Ptₜₑₜ@Ni(OH)₂ can be largely recovered after surface cleaning in repeated cycling test, indicating that the activity degradation of the Ptₜₑₜ@Ni(OH)₂ during the HER stability test is mostly due to the accumulation of H₂ bubbles that cover the Pt sites or other modification of local environment, with very little catalyst degradation. Nonetheless, more severe irreversible degradations are observed in Ptₜₑₜ and Pt/C control samples, in which the degraded activity can only be partially recovered with the CV scan to 1.1 V, further confirming the high durability of Ptₜₑₜ@Ni(OH)₂ with Ni(OH)₂ shell protection FIG. 20C illustrates Pt percentage loss before and after stability test. BOL: beginning of life; EOL: end of life. The Ptₜₑₜ@Ni(OH)₂ catalyst only show <4% Pt loss, which may be largely attributed to the detachment of some nanoparticles when the electrode was initially immersed into the electrolyte because the activity can be fully recovered after surface cleaning in the repeated cycling test. The loss for Ptₜₑₜ and Pt/C is about 7% and 15% respectively, further confirming that the Ni(OH)₂ can effectively reduce the Pt loss for enhancing stability.

FIGS. 21A to 21C are graphs of example ideal polarization curves of HER/HOR branch for (FIG. 21A) Volmer(rds)-Tafel pathway, (FIG. 21B) Volmer(rds)-Heyrovsky pathway; and (FIG. 21C) Volmer-Heyrovsky(rds) pathway. α=β=0.5 is used in the model. The HER branch represents the HER in the N₂ purged electrolyte.

FIGS. 21D to 21F are graphs illustrating the B-V fitting results matched properly with the experimental polarization curves. FIG. 21D is for Pt/C. The best B-V fitting results still cannot properly reconstruct the experimental polarization curves in the case of (FIG. 21E) PtNi/C, and (FIG. 21F) Ptₜₑₜ@Ni(OH)₂. (All the above tests are conducted under 1 M KOH, with N₂ purge and 1600 r.p.m. rotating speed).

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

Among other things, the present disclosure includes a recognition that, analogous to natural enzymes, an elaborated design of catalytic systems with a specifically tailored local chemical environment could substantially improve reaction kinetics, effectively combat catalyst poisoning effect and boost catalyst lifetime under unfavorable reaction conditions. According to certain aspects, therefore, embodiments relate to a unique design of “Ni(OH)₂-clothed Pt-tetrapods” with an amorphous Ni(OH)₂ shell as a water dissociation catalyst and a proton conductive layer to ensure abundant proton supply while isolating the Pt core from bulk alkaline electrolyte and rejecting undesired poisoning species. This design creates a favorable local chemical environment with efficient proton supply to the active Pt sites, resulting in acidic-like HER kinetics with a lowest Tafel slope of 27 mV/decade and a record-high specific activity and mass activity in alkaline electrolyte. The proton conductive Ni(OH)₂ shell effectively rejects impurity ions and retards the Oswald ripening, endowing a high tolerance to solution impurities and long-term durability that is difficult to achieve in the naked Pt-catalysts. The markedly improved alkaline HER activity and durability promise an attractive catalyst material for alkaline water electrolyzers and renewable chemical fuel generation.

By way of background, water electrolysis is of increasing interest for converting intermittent renewable electricity (e.g. from solar cells and windmills) into high purity hydrogen. The electrochemical water-splitting reaction is comprised of two half-reactions: the cathodic hydrogen evolution reaction (HER) and anodic oxygen evolution reaction (OER). In general, the HER and OER display distinct kinetics in acidic and basic electrolytes and often require costly platinum group metal (PGM) catalysts. Platinum (Pt) is regarded as the best element to catalyze HER for its optimal hydrogen binding energy (HBE). (Cao, Z. et al. Platinum-nickel alloy excavated nano-multipods with hexagonal close-packed structure and superior activity towards hydrogen evolution reaction. Nature Communications 8, 15131, (2017); Danilovic, N. et al. Enhancing the alkaline hydrogen evolution reaction activity through the bifunctionality of Ni (OH)₂/metal catalysts. Angewandte Chemie 124, 12663-12666, (2012); Yin, H. et al. Ultrathin platinum nanowires grown on single-layered nickel hydroxide with high hydrogen evolution activity. Nature communications 6, 6430, (2015); Zhao, Z. et al. Surface-engineered PtNi-O nanostructure with record-high performance for electrocatalytic hydrogen evolution reaction. Journal of the American Chemical Society 140, 9046-9050, (2018); Subbaraman, R. et al. Trends in activity for the water electrolyser reactions on 3d M (Ni, Co, Fe, Mn) hydr (oxy) oxide catalysts. Nature materials 11, 550, (2012); Liu, Z. et al. Aqueous Synthesis of Ultrathin Platinum/Non-Noble Metal Alloy Nanowires for Enhanced Hydrogen Evolution Activity. Angewandte Chemie 130, 11852-11856, (2018))

In particular, the Pt catalysts feature a rather small overpotential for HER in the acidic condition where the cathodic HER is usually regarded as a trivial challenge. However, for the complete water electrolysis, the anodic OER in the acidic condition is considerably more challenging and often features large overpotential and limited durability even with the most advanced design of PGM catalysts (Reier, T., Nong, H. N., Teschner, D., Schlogl, R. & Strasser, P. Electrocatalytic Oxygen Evolution Reaction in Acidic Environments—Reaction Mechanisms and Catalysts. Advanced Energy Materials 7, 1601275, (2017)). On the other hand, the OER in the alkaline condition is much more friendly and can be readily facilitated with non-precious metal (e.g. Ni, Fe, Co, etc.) oxide/hydroxide catalysts, offering considerable kinetic and cost benefits (Suen, N.-T. et al. Electrocatalysis for the oxygen evolution reaction: recent development and future perspectives. Chemical Society Reviews 46, 337-365, (2017)). With the continued development of anion exchange membranes (AEMs) of lower resistance and lower hydrogen diffusivity (Schalenbach, M. et al. Acidic or Alkaline? Towards a New Perspective on the Efficiency of Water Electrolysis. Journal of The Electrochemical Society 163, F3197-F3208, (2016)), alkaline electrolysis is becoming an increasingly attractive alternative for commercial electrolyzers (Leng, Y. et al. Solid-State Water Electrolysis with an Alkaline Membrane. Journal of the American Chemical Society 134, 9054-9057, (2012); Abbasi, R. et al. A Roadmap to Low-Cost Hydrogen with Hydroxide Exchange Membrane Electrolyzers. Advanced Materials 0, 1805876, (2019)).

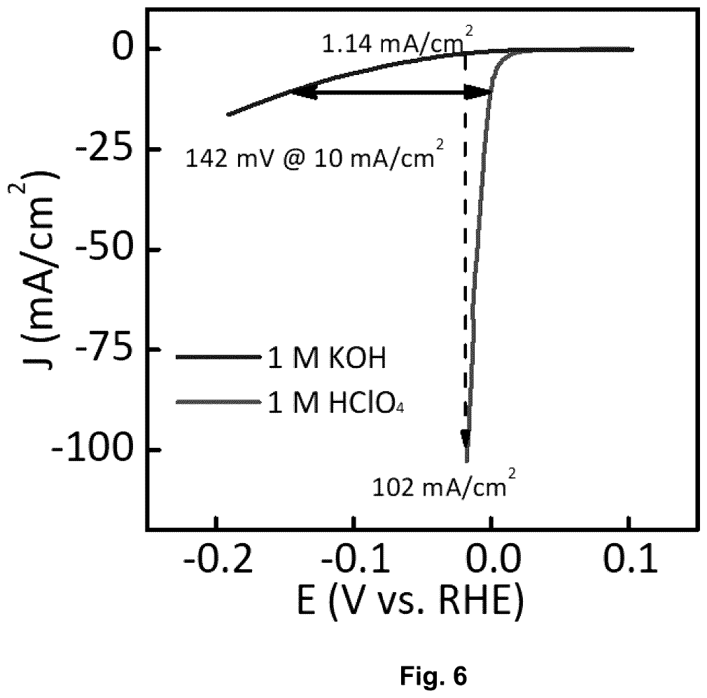

However, the HER kinetics in the alkaline condition is considerably slower. Even with the Pt catalysts, the HER rate is orders of magnitude lower than that in the acidic electrolyte because of the sluggish water dissociation step and the poor proton supply rate (FIG. 6) (Tian, X., Zhao, P. & Sheng, W. Hydrogen Evolution and Oxidation: Mechanistic Studies and Material Advances. Advanced Materials 31, 1808066, (2019)). Therefore, unlike the commonly perceived “easy” HER in the acidic electrolyte, the HER in the alkaline condition represents a major challenge for alkaline water electrolyzers (Energy, U. S. D. o. Hydrogen and Fuel Cells Program: 2019 Annual Merit Review and Peer Evaluation Report. (2019); Zeng, K. & Zhang, D. Recent progress in alkaline water electrolysis for hydrogen production and applications. Progress in Energy and Combustion Science 36, 307-326, (2010)). Considerable efforts have been placed on tailoring the Pt active sites to optimize HBE and HER kinetics. Beyond the active sites, the local chemical species can compete for adsorption for active sites, inactivate (poison) the catalytic sites, or profoundly affect the mass transfer of feedstocks/products (Cao, L. et al. Atomically dispersed iron hydroxide anchored on Pt for preferential oxidation of CO in H₂. Nature 565, 631-635, (2019); Shen, K., Chen, X., Chen, J. & Li, Y. Development of MOF-Derived Carbon-Based Nanomaterials for Efficient Catalysis. ACS Catalysis 6, 5887-5903, (2016)). Additionally, catalysts are inherently dynamic materials whose structures may evolve continuously during the adsorption of reactants and desorption of products, which could dictate the catalyst stability and lifetime.

In general, the local chemical environment plays a fundamental role in determining the reaction pathway and kinetics on the catalytic surface. A practical water electrolysis requires the concerted supply of the reactants and removal of the products under specific operating conditions to achieve high activity, tolerance to impurities in water, and long lifetime. To this end, a comprehensive approach that integrates electrocatalytic active site design with rational strategies to manipulate nanoscale mass/charge transport, ion separation, or structural evolution is highly desired for designing high-performing electrocatalysts that can facilitate efficient electron transfer and chemical transformations under practical conditions. This is analogous to the natural enzymes where precisely tailored micro-environment works in concert with the active sites to ensure superior activity, selectivity, and durability under practical solution conditions. Such an elaborate design is particularly important for alkaline water electrolysis where the local chemical environment near the active Pt sites in alkaline electrolytes is far more complex than that in an acidic electrolyte due to the limited proton supply rate, competitive adsorption of positively charged alkali metal cations (vs. protons) or other undesirable strong binding impurities (e.g., Cl⁻) that could poison the catalytic sites.

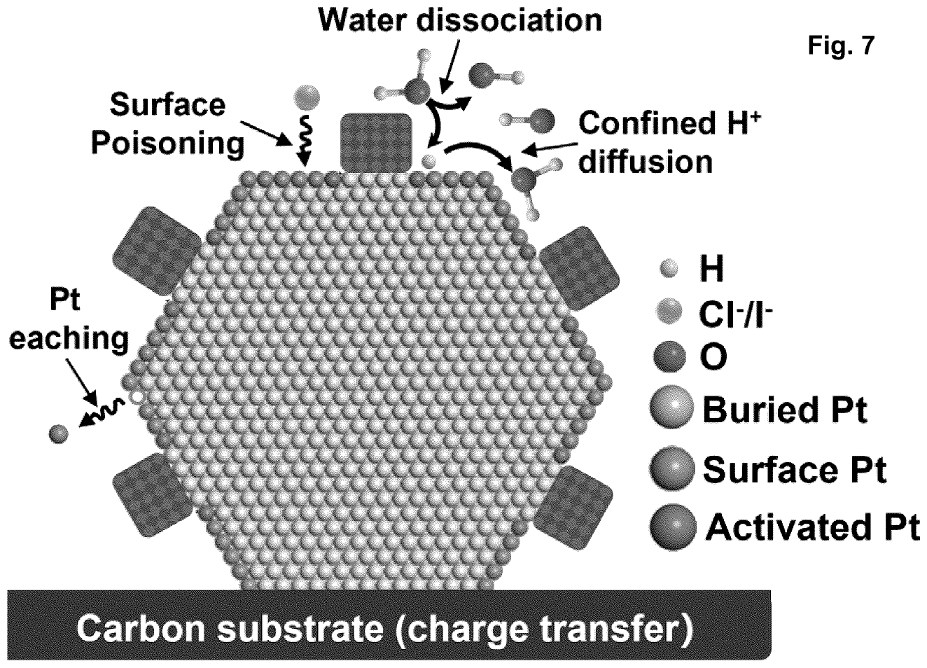

Surface decoration has been recognized as an effective approach for tailoring the local chemical environment near the active sites. For example, the decoration of crystalline NiO or NiSₓ particles on Pt surface has been reported to improve HER specific activity (SA, activity normalized by electrochemical surface area: ECSA) in the alkaline electrolyte (Wang, P. et al. Precise tuning in platinum-nickel/nickel sulfide interface nanowires for synergistic hydrogen evolution catalysis. Nature Communications 8, 14580, (2017); Wang, P., Jiang, K., Wang, G., Yao, J. & Huang, X. Phase and Interface Engineering of Platinum-Nickel Nanowires for Efficient Electrochemical Hydrogen Evolution. Angewandte Chemie International Edition 55, 12859-12863, (2016)), which has been mostly attributed to enhanced water dissociation kinetics facilitated by the Ni species. However, such crystalline Ni species are less permeable to protons and partly block the surface active sites (see FIG. 7) to reduce proton-accessible ECSA and compromise the overall mass activity (MA, activity normalized by mass loading) (Id.).

Additionally, the protons generated from Ni catalyzed water dissociation could be rapidly consumed within ˜1 nm (see notes below) through reassociation with the abundant hydroxyl in alkaline electrolyte. Thus, only a small fraction of Pt sites in close proximity of the decorated Ni species can benefit from the improved water dissociation kinetics on decorated Ni species, while most Pt sites farther away from Ni species are barely impacted (see FIG. 7). In this way, although the surface decoration with the crystalline Ni species could facilitate the water dissociation and partly accelerate the HER kinetics, most of the surface Pt sites in such decorated catalysts remain exposed to the bulk alkaline electrolyte, and the HER kinetics largely retain the alkaline HER characteristics with the Vomer- and Heyrovsky-step limited kinetics (Table 1). Moreover, the exposed Pt surface sites could undergo severe Oswald ripening during HER and gradually lose the designed nanostructure and the original activity.

To address the above and other challenges, the present embodiments relate to a core-shell nanostructure that is able to create a local chemical environment that can provide efficient proton (H⁺) supply to the Pt active sites and greatly boost HER performance in alkaline medium. In a particular example, the present embodiments include a “Ni(OH)₂-clothed Pt-tetrapod” in which the proton conductive amorphous Ni(OH)₂ tailors a local chemical environment for optimum HER in bulk alkaline electrolyte. For example, the “Ni(OH)₂-clothed Pt-tetrapod” ([Ptₜₑₜ@Ni(OH)₂]) structure offers an ideal geometry for isolating most of the Pt surface sites from the bulk alkaline electrolyte and rejecting undesired poisoning species while allowing the less encapsulated “feet” to make robust electrical contacts with the carbon support for efficient electron transport to the catalytic sites. The amorphous Ni(OH)₂ shell functions as an effective water dissociation catalyst and a low-barrier proton conductive layer to ensure efficient proton supply to the interfacial Pt sites, creating a proton-enriched local environment and fundamentally altering the HER to kinetics to the acidic-like Tafel-step limited pathway. The proton conductive Ni(OH)₂ shell effectively rejects impurity ions and retards Oswald ripening process, endowing a high tolerance to water impurities and long-term durability not attainable in the naked Pt-catalysts.

It should be noted that although the present embodiments will be described with respect to a useful example of Ptₜₑₜ@Ni(OH)₂, those skilled in the art will appreciate that the example can be extended to a more general composition of A@BOₓH_{y}), where A can be a precious metal such as Pt, Au, etc., and B can be Fe, Co, Ni, Ru, Rh, Si, etc. Those skilled in the art will understand how to extend the principles of the present embodiments to such other alternatives after being taught by the present examples.

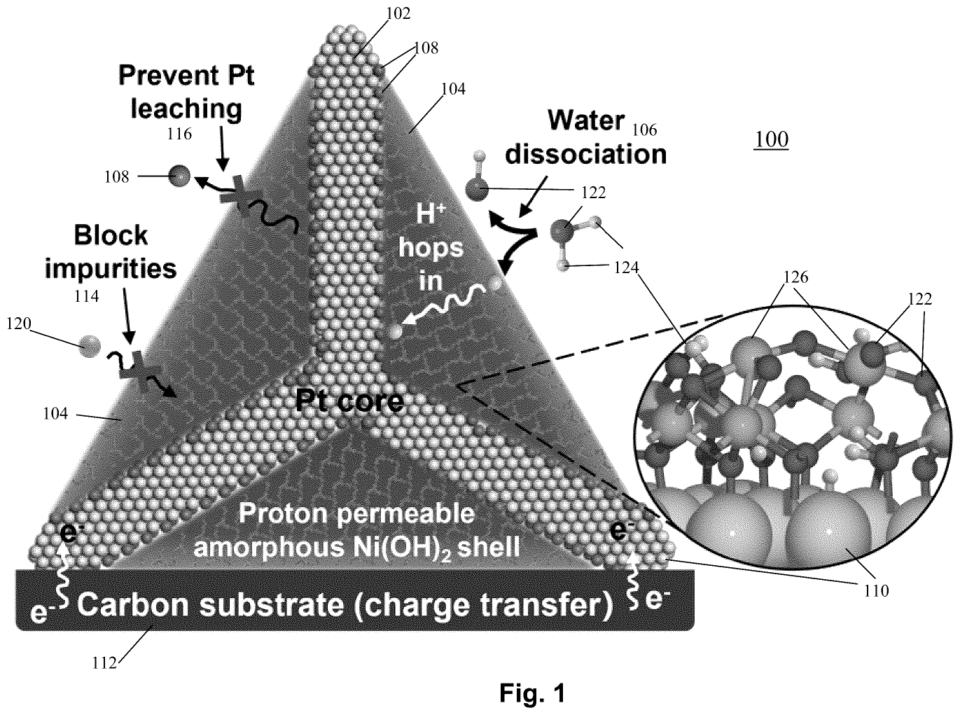

An example core-shell nanostructure according to embodiments is shown in FIG. 1. As shown in FIG. 1, the example [Ptₜₑₜ@Ni(OH)₂] structure 100 consists of a Pt nano-tetrapod (Ptₜₑₜ) core 102 as the HER catalyst and an amorphous Ni(OH)₂ shell 104 as the water dissociation (WD) catalysts and proton conductive layer. In accordance with aspects of embodiments, the hydrogen-bond framework in the amorphous Ni(OH)₂ layer 104 stabilizes the intermediate state of the WD step and facilitates water dissociation 106 into OH⁻ and H⁺, with OH⁻ diffusing into the alkaline electrolyte and the H⁺ efficiently transporting to the Pt surface through the amorphous Ni(OH)₂ matrix following a low-barrier cascade pathway (Grotthuss-like mechanism). The rapid water dissociation and low-barrier proton permeation through amorphous Ni(OH)₂ matrix provide abundant proton supply to the active Pt 108 sites (Elbaz, Y., Furman, D. & Caspary Toroker, M. Hydrogen transfer through different crystal phases of nickel oxy/hydroxide. Physical Chemistry Chemical Physics 20, 25169-25178, (2018); Beatty, M. E. S., Chen, H., Labrador, N. Y., Lee, B. J. & Esposito, D. V. Structure-property relationships describing the buried interface between silicon oxide overlayers and electrocatalytic platinum thin films. Journal of Materials Chemistry A 6, 22287-22300, (2018)), fundamentally altering the HER kinetics to the acidic-like Tafel step limited pathway. Meanwhile, the tetrapod feet feature intrinsically thinner Ni(OH)₂ decoration layer 106 (comprising Ni 126, O 122 and H 124 interconnected with buried Pt 110 as shown in the inset of FIG. 1) and geometrically and electrically favorable contacting point with the carbon support 112 (Sun, B., Snaith, H. J., Dhoot, A. S., Westenhoff, S. & Greenham, N. C. Vertically segregated hybrid blends for photovoltaic devices with improved efficiency. Journal of Applied Physics 97, 014914, (2005)) to ensure efficient electron transfer to the catalytic sites for electrocatalytic process. Additionally, the encapsulation by the proton conductive Ni(OH)₂ efficiently rejects 114 water impurity ions (e.g., Cl⁻ and I⁻ ions 120) and suppresses Pt atom leaching 116, leading to significantly enhanced tolerance to water impurities, long-term operation durability, and the overall catalyst lifetime. Together, the designed Ptₜₑₜ@Ni(OH)₂ catalysts display acidic-like HER kinetics, achieving a lowest Tafel slope of 27 mV/dec, a record-high specific activity, and mass activity (27.7±0.5 mA/cm² Pt and 13.4±0.4 A/mgPt at −70 mV vs. reversible hydrogen electrode: RHE) in alkaline electrolyte, along with excellent durability and tolerance towards halide anions not attainable in conventional naked Pt catalysts.

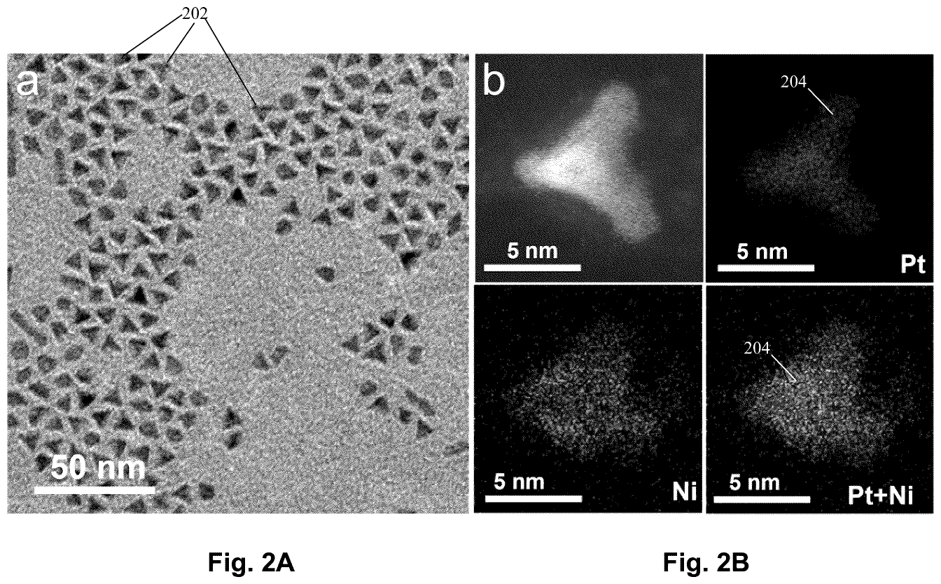

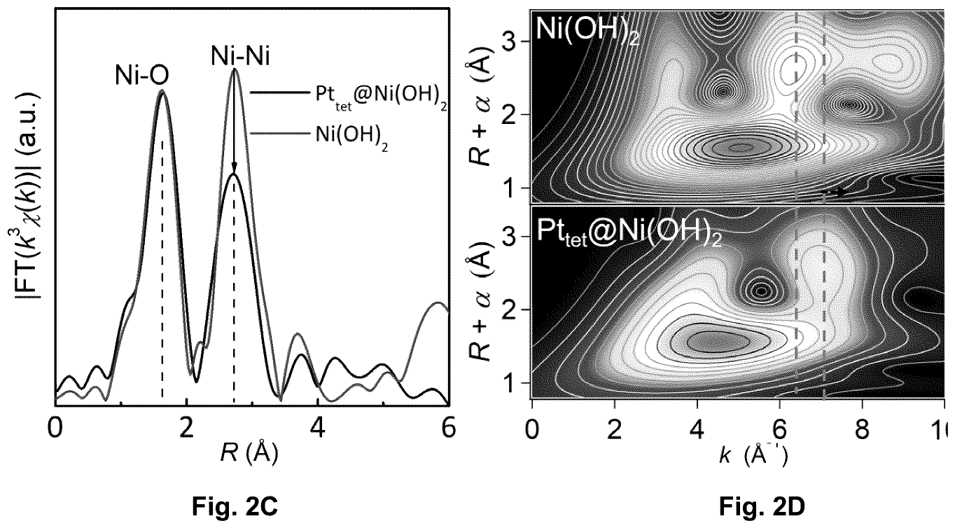

FIGS. 2A to 2D illustrate example structural characterizations of Ptₜₑₜ@Ni(OH)₂ nanocatalysts according to embodiments. For example, FIG. 2A is an example TEM image of Ptₜₑₜ@Ni(OH)₂. FIG. 2B is an example HAADF image of Ptₜₑₜ@Ni(OH)₂, along with example STEM-EDS mapping images of Pt, Ni, and Pt⁺Ni. FIG. 2C is a graph illustrating Ni K edge EXAFS-FT signals of Ptₜₑₜ@Ni(OH)₂ and α-Ni(OH)₂. The significantly lower peak intensity and broader peak width at half maximum for the Ni—Ni peak in Ptₜₑₜ@Ni(OH)₂ vs. crystalline α-Ni(OH)₂ reference indicates the amorphous nature of the Ni(OH)₂ shell. FIG. 2D are Wavelet transform (WT) diagrams for the Ni k3-weighted EXAFS signals of α-Ni(OH)₂ and Ptₜₑₜ@Ni(OH)₂. The positive shift of the Ni—Ni coordination signal from 6.4 to 7.0 Å⁻¹) in the k-space indicates Ni is also coordinated with a heavier element, which should be the Pt.

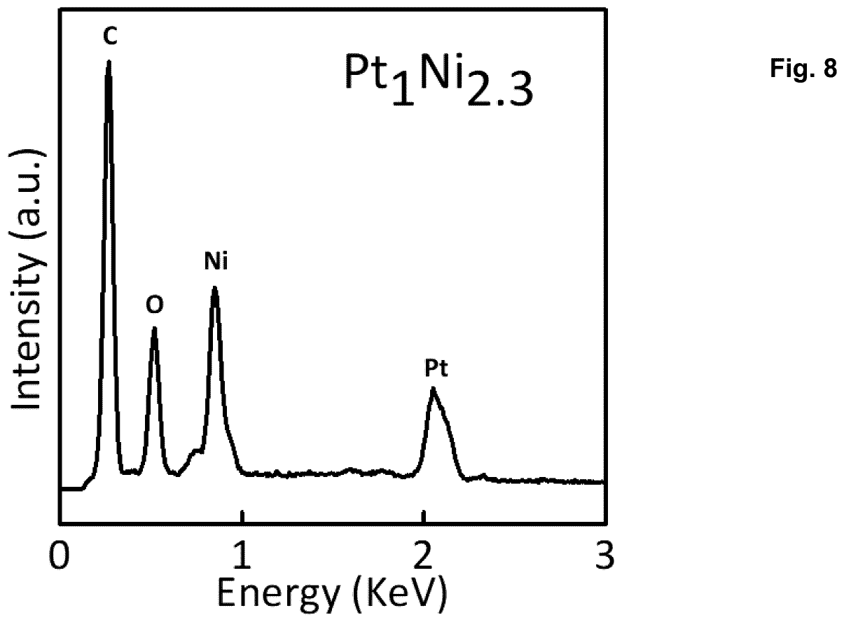

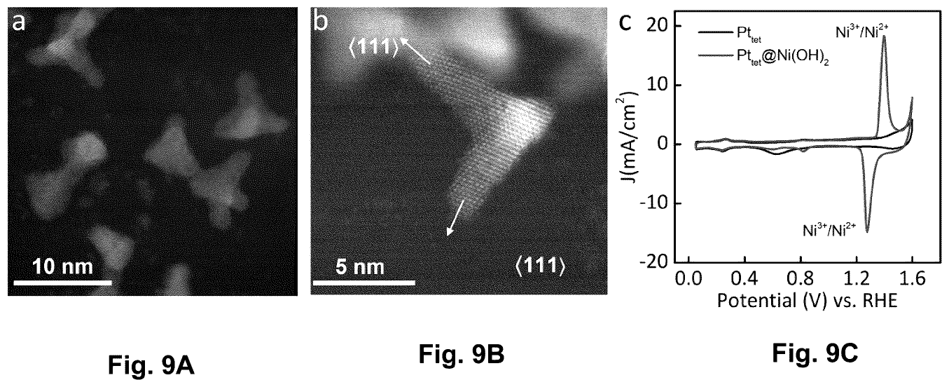

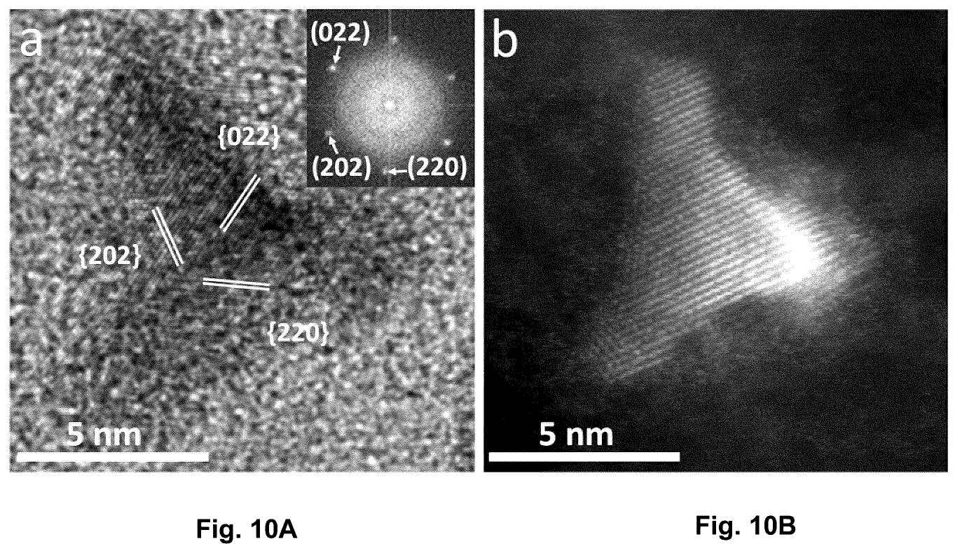

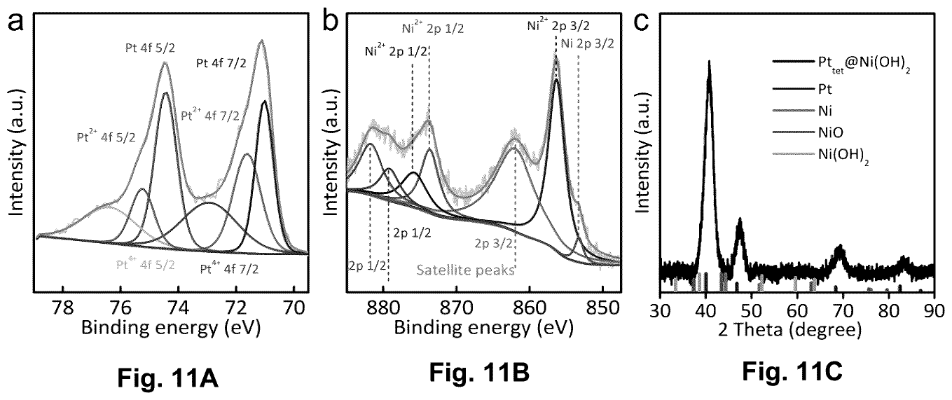

Additional aspects of the above and other characterizations are as follows. Ptₜₑₜ@Ni(OH)₂ nanoparticles were prepared through a facile one-pot synthesis as described in more detail below. Transmission electron microscopy (TEM) studies such as the example shown in FIG. 2A reveal the resulting nanoparticles 202 exhibit uniformly dispersed tetrahedral shapes. The high-angle-annular-dark-field scanning TEM (HAADF-STEM) and energy-dispersive X-ray spectroscopy (EDS) mapping studies such as those shown in FIG. 2B reveal the tetrahedral nanoparticle is composed of a Pt tetrapod core encapsulated in a Ni-containing shell to form an overall tetrahedral shape, with a total Pt/Ni atomic ratio of 1.0:2.3 (see FIG. 8). The high-resolution STEM images such as those shown in FIGS. 2A and 2B reveal the Pt tetrapods grow along <111> directions (see FIGS. 9A to 9C), while the Ni-containing shell shows no apparent crystalline order, indicating an amorphous nature (see FIGS. 10A and 10B). X-ray photoelectron spectroscopy (XPS) studies show Pt emission peaks can be assigned to Pt (0) with minor Pt(+2) species; while that of Ni are consistent with Ni(OH)₂ (see FIGS. 11A to 11C) (Li, H. B. et al. Amorphous nickel hydroxide nanospheres with ultrahigh capacitance and energy density as electrochemical pseudocapacitor materials. Nature Communications 4, 1894, (2013); Huang, W. et al. Highly active and durable methanol oxidation electrocatalyst based on the synergy of platinum-nickel hydroxide-graphene. Nature Communications 6, 10035, (2015); Payne, B. P., Biesinger, M. C. & McIntyre, N. S. The study of polycrystalline nickel metal oxidation by water vapour. Journal of Electron Spectroscopy and Related Phenomena 175, 55-65, (2009); Mansour, A. N. Characterization of P—Ni(OH)₂ by XPS. Surface Science Spectra 3, 239-246, (1994); Peck, M. A. & Langell, M. A. Comparison of Nanoscaled and Bulk NiO Structural and Environmental Characteristics by XRD, XAFS, and XPS. Chemistry of Materials 24, 4483-4490, (2012)). X-ray diffraction (XRD) studies show all diffraction peaks can be assigned to face-centered cubic Pt (see FIGS. 11A to 11C), with no apparent diffraction peaks for nickel species, (Mathew, K., Sundararaman, R., Letchworth-Weaver, K., Arias, T. A. & Hennig, R. G. Implicit solvation model for density-functional study of nanocrystal surfaces and reaction pathways. The Journal of Chemical Physics 140, 084106, (2014); Rebollar, L. et al. “Beyond Adsorption” Descriptors in Hydrogen Electrocatalysis. ACS Catalysis 10, 14747-14762, (2020); Nai, J., Wang, S., Bai, Y. & Guo, L. Amorphous Ni(OH)₂ Nanoboxes: Fast Fabrication and Enhanced Sensing for Glucose. Small 9, 3147-3152, (2013)) further confirming the amorphous nature of the Ni(OH)₂ shell. It is interesting to note that STEM EDS mapping studies such as those shown in FIG. 2B indicate the Pt-tetrapod body 204 is well encapsulated by the amorphous Ni(OH)₂ shell, while the Pt-tetrapods feet (tips) are less encapsulated. Previous studies suggested that the Ni adatoms tend to fill the concave sites of the Pt multi-pod structure following a step-site induced layer-by-layer deposition process (Gan, L. et al. Element-specific anisotropic growth of shaped platinum alloy nanocrystals. Science 346, 1502-1506, (2014)). Such a concave-site filling process on Pt-tetrapods would eventually saturate all concave sites of four (111) faces, forming tetrahedral structures with intrinsically less encapsulated tetrapod feet on four convex corners, producing a unique structure of “Ni(OH)₂— clothed Pt-tetrapods”, which is ideally suited for isolating most of the Pt surface from the bulk alkaline electrolyte while allowing the less encapsulated tetrapod-feet to make robust electrical contacts with the carbon support for efficient electron transport to the catalytic sites (FIG. 1).

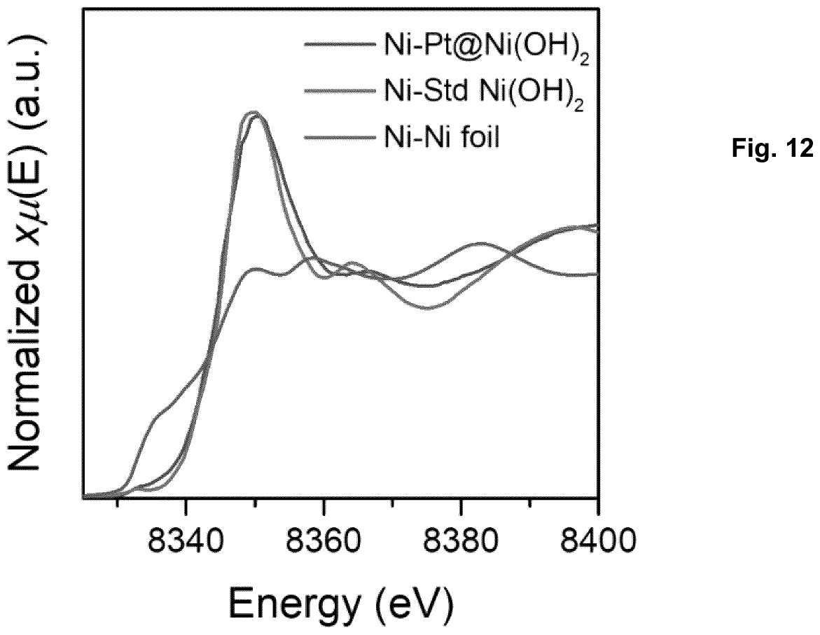

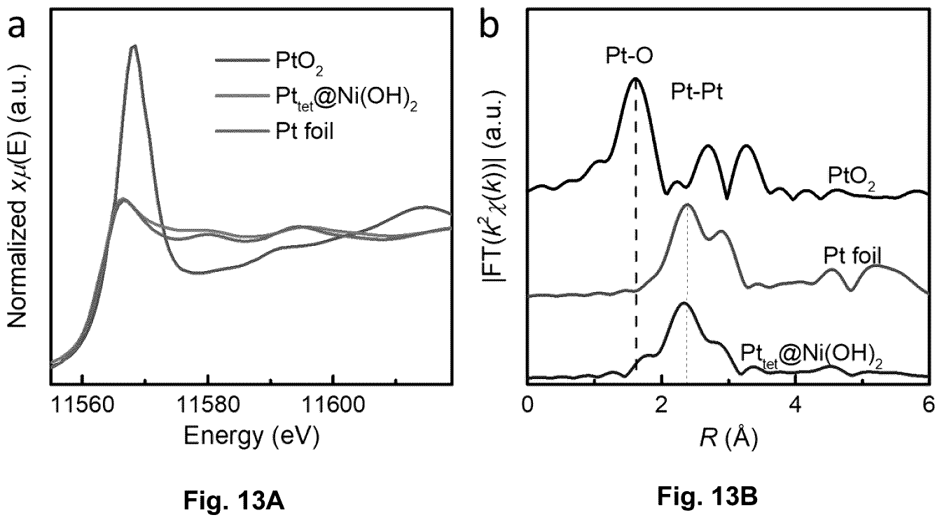

The Fourier transform (FT) extended X-ray absorption fine structure (EXAFS) signal of Ptₜₑₜ@Ni(OH)₂ such as that shown in FIG. 2C exhibits a major peak of Ni—O at 1.66 Å, and a second major peak of Ni—Ni at 2.69 Å. It is noted that the corresponding peak intensities for the Ni—Ni peaks (second coordination sphere) are considerably lower than that of standard α-Ni(OH)₂, suggesting abundant Ni defects in the Ni(OH)₂ shell and the high level of structural disorder. Additionally, the Ptₜₑₜ@Ni(OH)₂ features a notably broader Ni—Ni peak at half maximum with a considerably larger Debye-Waller factor than that of the standard crystalline α-Ni(OH)₂ (Table 2), further suggesting the amorphous nature of the Ni(OH)₂ in Ptₜₑₜ@Ni(OH)₂ and consistent with the results obtained in TEM and XRD studies. The X-ray absorption near edge structure (XANES) spectra of Ni K-edge and Pt L3-edge suggest that the oxidation state of Ni is slightly lower than +2, while the oxidation state of Pt is slightly higher than 0 (FIGS. 12 and 13), indicating a partial charge transfer from Pt to the Ni(OH)₂ at the interface. This charge transfer is also confirmed by the density functional theory (DFT) calculations of the Bader charge of interfacial Pt and Ni atoms in the next section.

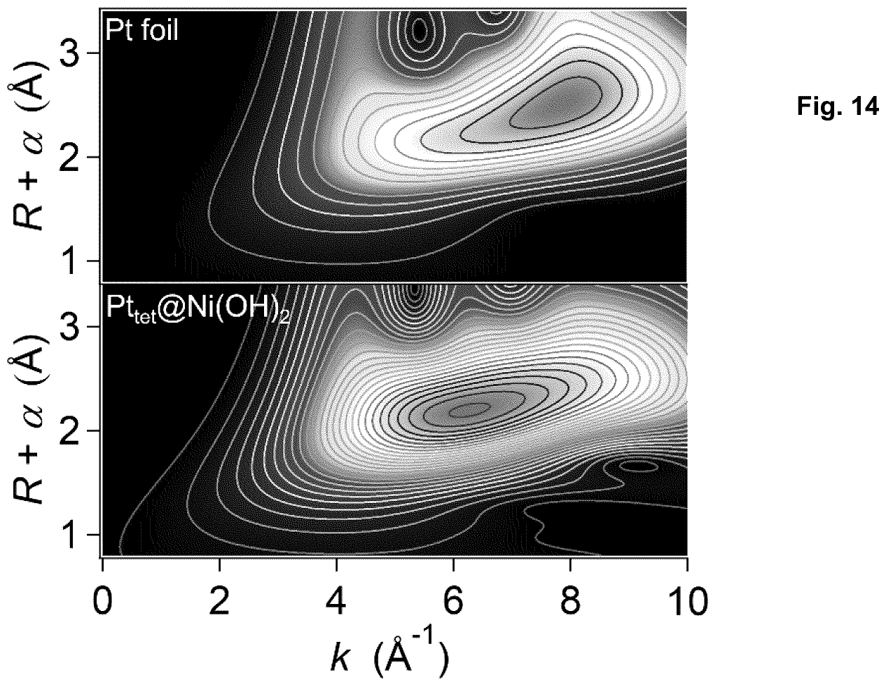

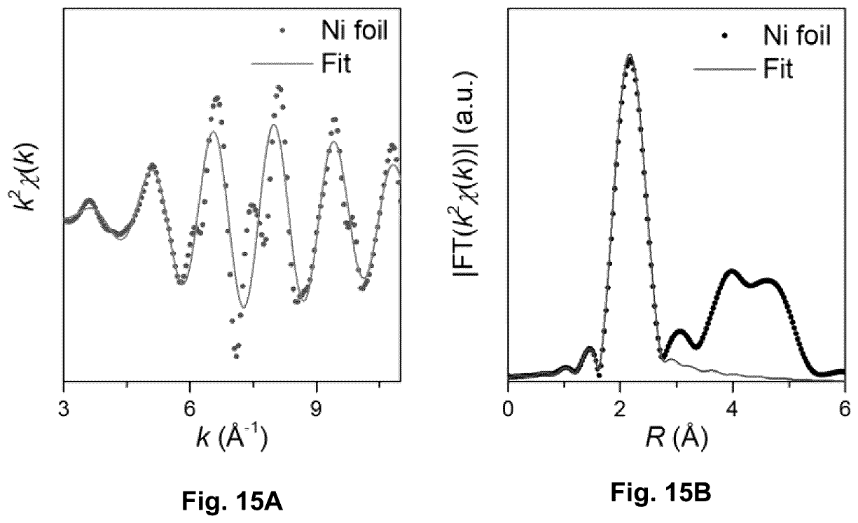

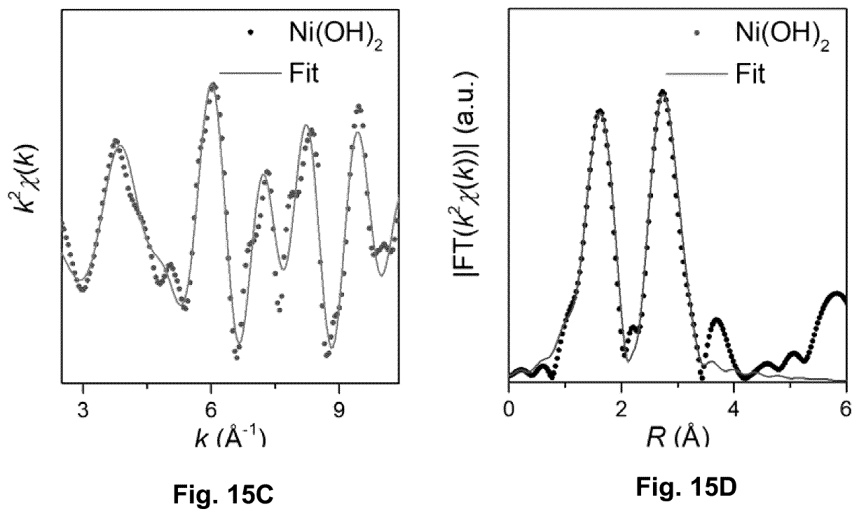

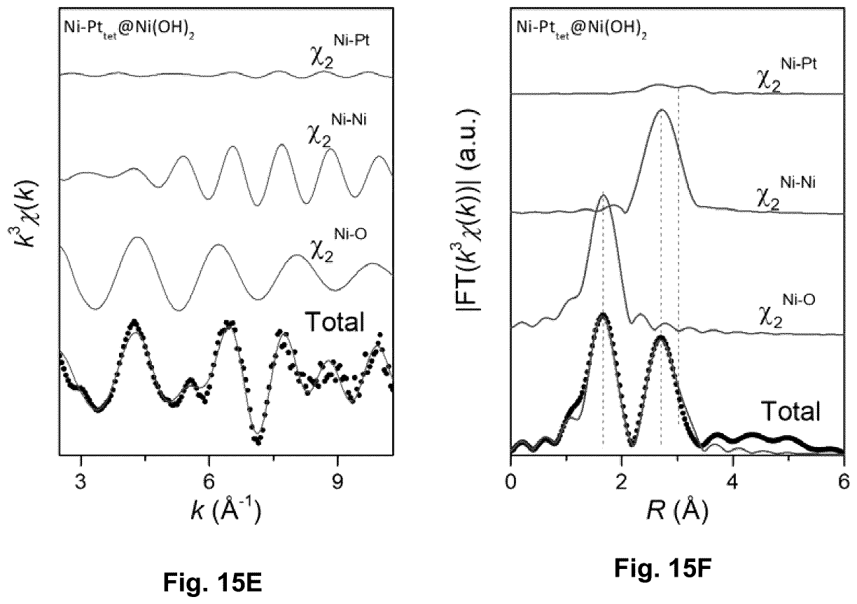

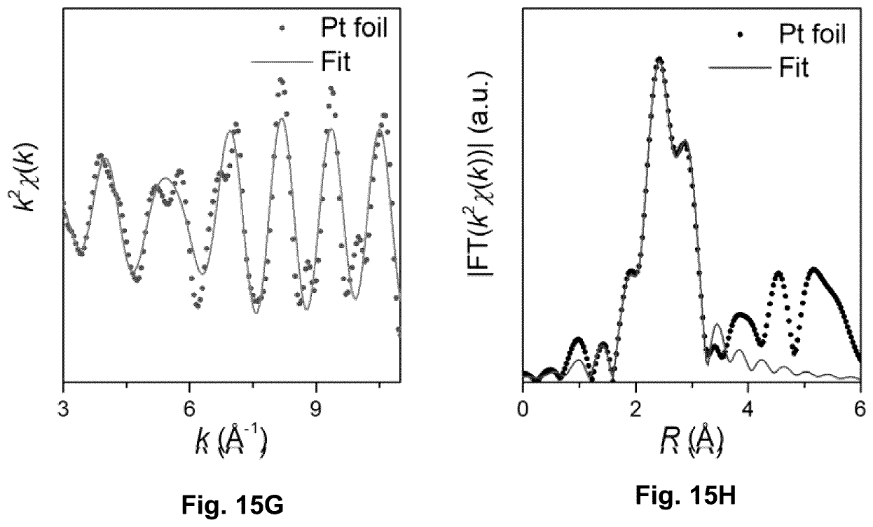

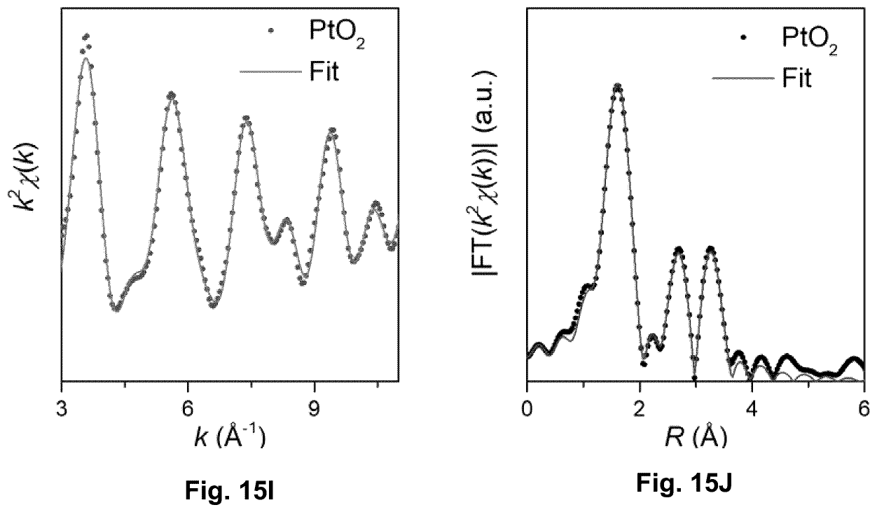

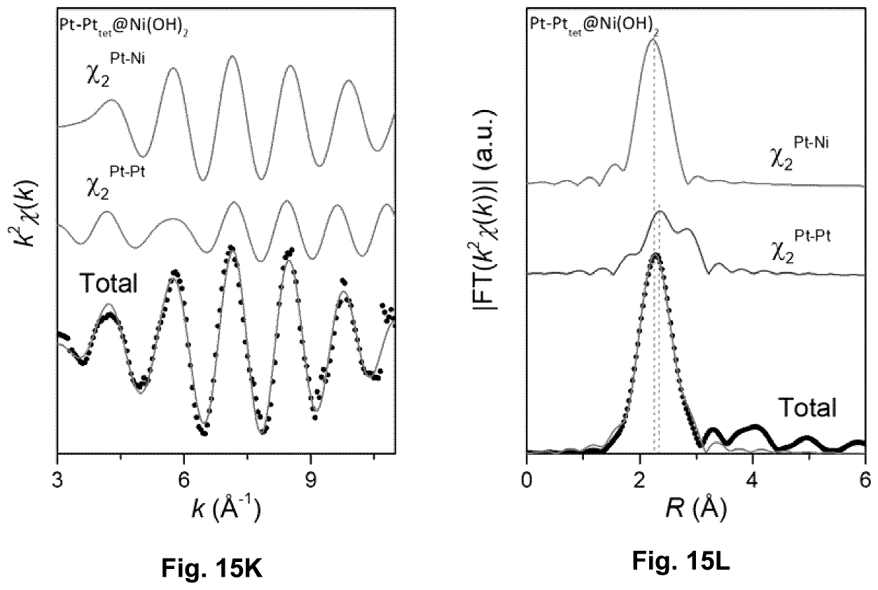

EXAFS wavelet transform (WT) analysis is powerful for discriminating the backscattering atoms. As shown in FIG. 2D, the main signal of Ni—Ni coordination in this example lies at 6.4 Å⁻¹ in the k-space for standard Ni(OH)₂ reference, which shifts towards higher values (7.0 Å⁻¹) for Ptₜₑₜ@Ni(OH)₂, indicating the existence of Ni—Pt coordination. This is also consistent with the negative shift of Pt—Pt k value observed in Pt-L3 edge EXAFS-WT analysis for Ptₜₑₜ@Ni(OH)₂ (see FIG. 14). Based on the EXAFS-WT results, the EXAFS spectrum of the Ptₜₑₜ@Ni(OH)₂ was analyzed by quantitative least-square EXAFS curve-fitting using backscattering paths of Ni—Pt, Ni—Ni, and Ni—O (see FIGS. 15A to 15L and Tables 2 and 3). The best-fitting results show that the bonding distance of Ni—Pt coordination is 3.10 Å, considerably larger than the 2.66 Å Ni—Pt distance in the PtNi alloy, indicating that the Ni and Pt atoms in Ptₜₑₜ@Ni(OH)₂ are likely bridged by O atoms. This is further confirmed by the DFT studies in the following section.

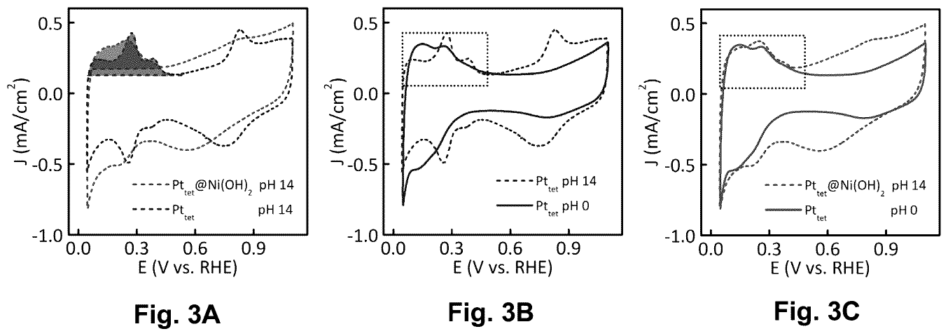

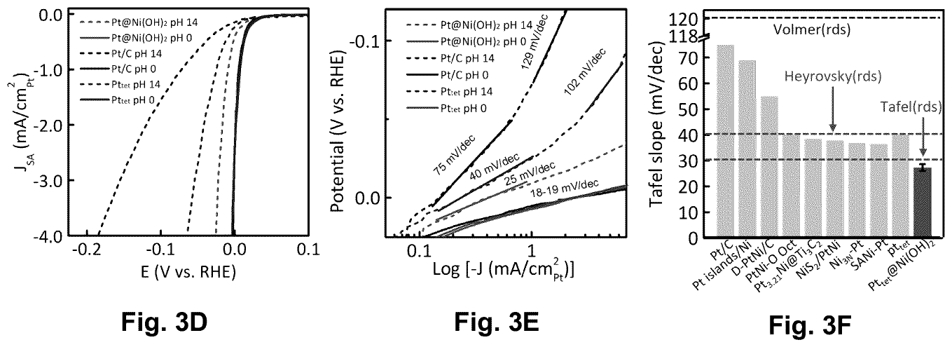

Since it is difficult to directly evaluate the proton permeability through the amorphous Ni(OH)₂ layer, the present Applicants have compared cyclic voltammetry (CV) characteristics of Ptₜₑₜ@Ni(OH)₂ and the naked Ptₜₑₜ in the alkaline electrolyte to evaluate the proton accessibility of the Ni(OH)₂ encapsulated Pt core in Ptₜₑₜ@Ni(OH)₂ according to embodiments, as illustrated in FIGS. 3A to 3F. For example, FIG. 3A is a graph illustrating the cyclic voltammetry (CV) curves of the Ptₜₑₜ@Ni(OH)₂ and naked Ptₜₑₜ in 1.0 M KOH. As shown, the Pt ECSA of the Ptₜₑₜ@Ni(OH)₂ with full Ni(OH)₂ shell is about −80% of the ECSA of the naked Ptₜₑₜ, confirming the proton permeability through the amorphous Ni(OH)₂ shell. FIG. 3B is a graph illustrating the CV curves of the naked Ptₜₑₜ under pH 0 and 14, and show distinct characteristics in the hydrogen adsorption/desorption region. FIG. 3C is a graph illustrating the CV curves of Ptₜₑₜ@Ni(OH)₂ under pH 0 and 14, which show highly comparable characteristics in hydrogen adsorption/desorption region, indicating a largely comparable proton supply near the Pt sites in Ptₜₑₜ@Ni(OH)₂ even in bulk alkaline electrolyte. FIG. 3D is a graph providing polarization curves (specific activity) of Ptₜₑₜ@Ni(OH)₂, Ptₜₑₜ, and Pt/C in pH 0 and 14, respectively. FIG. 3E is a graph illustrating Tafel slopes of Ptₜₑₜ@Ni(OH)₂, Ptₜₑₜ and Pt/C pH 0 and 14, respectively. FIG. 3F is a chart providing a comparison of the Tafel slopes of Ptₜₑₜ@Ni(OH)₂ with current state-of-the-art alkaline HER catalysts. The dotted lines represent the Tafel slopes determined by three distinct rate-determining steps (rds): Volmer step (top); Heyrovsky step (middle), and Tafel step (bottom). All previous studies of Pt or modified Pt catalysts show a Tafel slope of −40 mV/dec or above in alkaline electrolytes, consistent with a Volmer step or Heyrovsky limited mechanism, while the Tafel slope achieved with the present Ptₜₑₜ@Ni(OH)₂ catalysts is below 29.6 mV/dec, comparable to the typical values observed in the acidic electrolyte, suggesting abundant proton supply near Pt surface in the example design of Ptₜₑₜ@Ni(OH)₂ catalysts according to embodiments despite the bulk alkaline electrolyte.

In the above characterizations, the naked Ptₜₑₜ was obtained by completely etching the Ni(OH)₂ shell in the acidic electrolyte (see FIGS. 9A to 9C). Based on the CV curves, the proton-accessible ECSA can be quantified by the integration of the hydrogen desorption region (0.05-0.45 V vs. RHE). Interestingly, the ECSA of the original Ptₜₑₜ@Ni(OH)₂ with full Ni(OH)₂ encapsulation is about 80% of the naked Ptₜₑₜ obtained after completely removing the surface Ni(OH)₂, indicating that the Pt sites in the Ptₜₑₜ@Ni(OH)₂ coreshell structures are mostly accessible to the H⁺ even with the encapsulation by the Ni(OH)₂ shell, suggesting the proton permeability of the Ni(OH)₂ shell.

Most Pt catalysts typically exhibit notably different CV in acidic or alkaline electrolytes with highly distinct behavior in the hydrogen desorption region (Hᵤₚd) region due to distinct local proton concentration and different hydrogen adsorption/desorption potential (Sheng, W. et al. Correlating hydrogen oxidation and evolution activity on platinum at different pH with measured hydrogen binding energy. Nature Communications 6, 5848, (2015); Wang, X., Xu, C., Jaroniec, M., Zheng, Y. & Qiao, S.-Z. Anomalous hydrogen evolution behavior in high-pH environment induced by locally generated hydronium ions. Nature Communications 10, 4876, (2019)). Indeed, the naked Ptₜₑₜ shows a rather different CV behavior in the alkaline vs. acidic conditions, as illustrated in FIG. 3B, consistent with previous studies. On the other hand, it is interesting to note from FIG. 3C that the CV curves of the Ptₜₑₜ@Ni(OH)₂ in the alkaline electrolyte show rather similar behavior in the Hupd region to that of the naked Ptₜₑₜ in the acidic electrolyte, indicating a largely comparable proton supply near the Pt sites in Ptₜₑₜ@Ni(OH)₂ even in bulk alkaline electrolyte.

The efficient proton supply could lead to considerably improved HER kinetics. To this end, the present Applicants have conducted linear scan voltammetry (LSV) and compared the HER polarization curves (normalized by hydrogen desorption area) of Ptₜₑₜ@Ni(OH)₂, naked Ptₜₑₜ, and Pt/C in pH 14 and pH 0 as shown in FIG. 3D. Expectedly, the Pt/C under pH 14 shows a markedly lower current than under pH 0. Similarly, the naked Ptₜₑₜ without the Ni(OH)₂ shell also shows considerably lower HER current in the alkaline electrolytes than that in acidic conditions. In contrast, the Ptₜₑₜ@Ni(OH)₂ shows a much more comparable HER polarization curve between the alkaline condition and the acidic condition, further suggesting a similar local chemical environment regardless of the entirely different bulk electrolytes. Additionally, the uninterrupted increase of the HER current from the Ptₜₑₜ@Ni(OH)₂ catalysts during the cathodic LSV scan as shown in FIG. 3D indicates that the amorphous Ni(OH)₂ layer is also H₂ permeable.

These specific HER kinetics can be highlighted by the Tafel slope analysis. The HER reaction follows three basic steps, with distinct rate-determining steps (rds) and Tafel slopes:
Volmer step: H₃O⁺+e⁻→H_{ad}+H₂O (acidic electrolyte)
Or: H₂O+e⁻→H_{ad}+OH⁻ (alkaline electrolyte)
Heyrovsky step: H_{ad}+H₃O⁺+e⁻→H₂T+H₂O (acidic electrolyte)
Or: H_{ad}+H₂O+e⁻→H₂T+OH⁻ (alkaline electrolyte)
Tafel step: 2H_{ad}→H₂T (both acidic and alkaline electrolyte)

Depending on the electrolyte conditions, one can expect distinct reaction kinetics. In the acidic electrolyte, the sufficient H⁺ supply ensures a Tafel-step limited HER pathway, with the Tafel step as the rds and an ideal Tafel slope of 29.6 mV/dec. In the alkaline electrolyte where the H⁺ is supplied by water dissociation, the HER reaction typically follows Volmer- or Heyrovsky-step limited pathway, with the Volmer step or Heyrovsky step as the rds, and ideal Tafel slopes of 118.4 and 39.5 mV/dec, respectively.

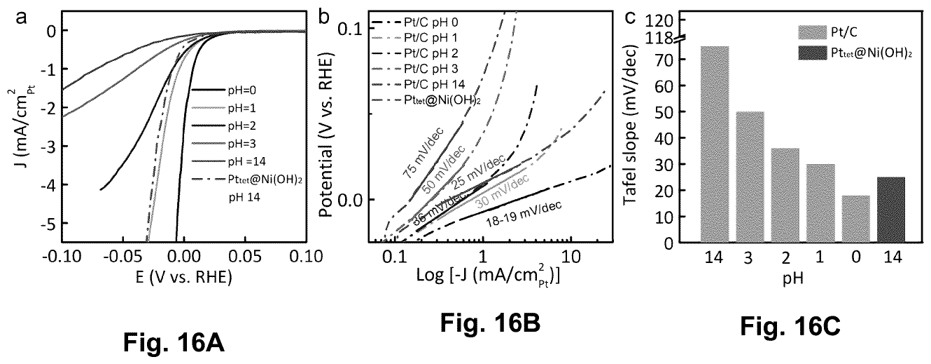

The Pt/C, naked Ptₜₑₜ, and Ptₜₑₜ@Ni(OH)₂ show a low and comparable Tafel slope of around 18-19 mV/dec at pH 0 in FIG. 3E, consistent with previous reports in the acidic environment and the well-accepted HER mechanism with the Tafel-step limited pathway described above (Podjaski, F. et al. Rational strain engineering in delafossite oxides for highly efficient hydrogen evolution catalysis in acidic media. Nature Catalysis 3, 55-63, (2020); Fang, S. et al. Uncovering near-free platinum single-atom dynamics during electrochemical hydrogen evolution reaction. Nature Communications 11, 1029, (2020); Li, F. et al. Balancing hydrogen adsorption/desorption by orbital modulation for efficient hydrogen evolution catalysis. Nature Communications 10, 4060, (2019); Liang, L. et al. Cobalt single atom site isolated Pt nanoparticles for efficient ORR and HER in acid media. Nano Energy 88, 106221, (2021)). The smaller than 29.6 mV/dec Tafel slope is possibly ascribed to the backward HOR reaction with H₂ in-situ generated on the Pt surface at a small HER overpotential regime and has also been commonly observed in previous works. (Id.) On the other hand, the Pt/C, naked Ptₜₑₜ, and Ptₜₑₜ@Ni(OH)₂ show distinct Tafel slopes of 75-129 mV/dec, 40-102 mV/dec, and 27 mV/dec at pH 14 (FIG. 3e). It is noted that Tafel slope derivation can be tricky in some situations (Zheng, J., Yan, Y. & Xu, B. Correcting the Hydrogen Diffusion Limitation in Rotating Disk Electrode Measurements of Hydrogen Evolution Reaction Kinetics. Journal of The Electrochemical Society 162, F1470-F1481, (2015); Rheinlander, P. J., Herranz, J., Durst, J. & Gasteiger, H. A. Kinetics of the Hydrogen Oxidation/Evolution Reaction on Polycrystalline Platinum in Alkaline Electrolyte Reaction Order with Respect to Hydrogen Pressure. Journal of The Electrochemical Society 161, F1448-F1457, (2014)), and have taken extra caution in deriving the Tafel slopes (See Supplementary Note 2) to ensure a fair and robust comparison. The much higher Tafel slopes observed for Pt/C and Ptₜₑₜ at pH 14 are consistent with the Volmer or Heyrovsky limited kinetics expected in the alkaline electrolyte, while the much lower Tafel slope of 27 mV/dec observed for Ptₜₑₜ@Ni(OH)₂ at pH 14 suggests a distinct Tafel step limited mechanism more similar to that in an acidic environment (Markovida, N. M., Sarraf, S. T., Gasteiger, H. A. & Ross, P. N. Hydrogen electrochemistry on platinum low-index single-crystal surfaces in alkaline solution. Journal of the Chemical Society, Faraday Transactions 92, 3719-3725, (1996); Markovié, N. M., Grgur, B. N. & Ross, P. N. Temperature-Dependent Hydrogen Electrochemistry on Platinum Low-Index Single-Crystal Surfaces in Acid Solutions. The Journal of Physical Chemistry B 101, 5405-5413, (1997); Shinagawa, T., Garcia-Esparza, A. T. & Takanabe, K. Insight on Tafel slopes from a microkinetic analysis of aqueous electrocatalysis for energy conversion. Scientific Reports 5, 13801, (2015); Zheng, Y., Jiao, Y., Vasileff, A. & Qiao, S.-Z. The Hydrogen Evolution Reaction in Alkaline Solution: From Theory, Single Crystal Models, to Practical Electrocatalysts. Angewandte Chemie International Edition 57, 7568-7579, (2018)). Indeed, a closer comparison of the HER activity of Ptₜₑₜ@Ni(OH)₂ in pH 14 with that of Pt/C under pH 0-3 condition indicates that the HER activity of Ptₜₑₜ@Ni(OH)₂ in pH 14 is largely comparable to that of Pt/C under pH 1 (see FIGS. 16A to 16C). These HER polarization analyses further suggest that the Pt sites in Ptₜₑₜ@Ni(OH)₂ feature a proton supply rate closed to that of an acidic environment (pH 1-2), consistent with the CV analyses discussed above.

It is interesting to note from FIG. 3F that the HER Tafel slope of 27 mV/dec achieved with Ptₜₑₜ@Ni(OH)₂ represents the lowest value achieved in the alkaline electrolyte, which is notably lower than those achieved previously with Pt or modified Pt catalysts in alkaline conditions (Li, M. et al. Single-atom tailoring of platinum nanocatalysts for high-performance multifunctional electrocatalysis. Nature Catalysis 2, 495-503, (2019); Wang, Y., Chen, L., Yu, X., Wang, Y. & Zheng, G. Superb Alkaline Hydrogen Evolution and Simultaneous Electricity Generation by Pt-Decorated Ni3N Nanosheets. Advanced Energy Materials 7, 1601390, (2017); Jiang, Y. et al. Coupling PtNi Ultrathin Nanowires with MXenes for Boosting Electrocatalytic Hydrogen Evolution in Both Acidic and Alkaline Solutions. Small 15, 1805474, (2019); Alinezhad, A. et al. Direct Growth of Highly Strained Pt Islands on Branched Ni 4 Nanoparticles for Improved Hydrogen Evolution Reaction Activity. Journal of the American Chemical Society 141, 16202-16207, (2019); Chen, H. et al. Effect of Atomic Ordering Transformation of PtNi Nanoparticles on Alkaline Hydrogen Evolution: Unexpected Superior Activity of the Disordered Phase. The Journal of Physical Chemistry C 124, 5036-5045, (2020); Wang, G., Huang, X., Liao, H.-G. & Sun, S.-G. Microstrain Engineered NiₓS₂/PtNi Porous Nanowires for Boosting Hydrogen Evolution Activity. Energy & Fuels 35, 6928-6934, (2021)). Although it has been reported that the surface decoration with Ni species may facilitate the water dissociation and partly accelerate the HER kinetics on Pt, most of the surface Pt sites in such decorated catalysts remain exposed to the bulk alkaline electrolyte, and the HER kinetics largely retain the alkaline HER characteristics with the Vomer and Heyrovsky step limited kinetics and an overall Tafel slope ˜40 mV/dec or larger (see Table 1). In contrast, a full encapsulation of Pt surface with a proton permeable amorphous Ni(OH)₂ in the present Ptₜₑₜ@Ni(OH)₂ core-shell catalysts isolates most active Pt sites from bulk alkaline electrolyte while ensuring sufficient proton supply to all Pt sites, thus fundamentally altering the HER pathway to acidic-like Tafel-step limited kinetics.

Although the WD kinetics of transition metal hydroxides have been suggested to explain the enhanced HER activity of Pt/transition metal oxide catalysts, a direct measurement of the enhanced WD steps on electrocatalyst is challenging due to the difficulties to decouple with subsequent hydrogen production steps. To directly elucidate the role of the amorphous Ni(OH)₂ shell as an efficient WD catalyst, the present Applicants tested the WD activity of the Ni(OH)₂ shell by using bipolar membrane (BPM) electrolysis. The BPM electrolysis is conducted in an H-cell where a combination of AEM and PEM is used to separate the acidic HER half-cell (pH=0) and alkaline OER half-cell (pH=14).

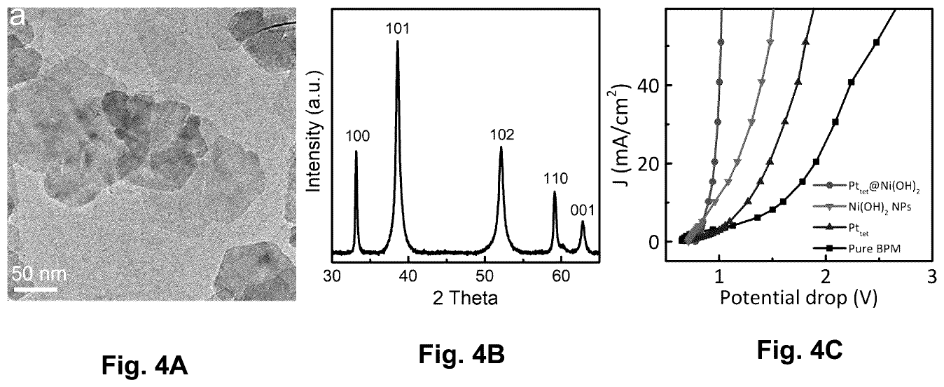

FIGS. 4A to 4C illustrate example aspects of Water dissociation performance of Pt/Ni(OH)₂ according to embodiments. For example, FIG. 4A is a TEM image of crystalline Ni(OH)₂ nanoplate. FIG. 4B is a graph illustrating an XRD pattern of crystalline Ni(OH)₂ nanoplate. FIG. 4C is a graph illustrating the water dissociation rate of Ptₜₑₜ, Ptₜₑₜ@Ni(OH)₂, crystalline Ni(OH)₂ nanoplates and pure BPM measured from BPM-based water electrolysis. As shown in FIG. 4C, the pure BPM with no catalyst, with the naked Ptₜₑₜ core or crystalline Ni(OH)₂ nanoplates catalysts require the overpotential of 1.64 V, 0.97 V, and 0.64 V, respectively, to reach the 50 mA/cm², while that with the amorphous Ni(OH)₂ shell (in Ptₜₑₜ@Ni(OH)₂) only needs 0.18 V overpotential to reach 50 mA/cm², demonstrating a much faster WD kinetics, and experimentally confirming that Ni(OH)₂ is the primary contributor to the WD, and the amorphous Ni(OH)₂ shell is more active for WD.

As shown, the Ptₜₑₜ@Ni(OH)₂ or Ptₜₑₜ were uniformly dispersed at the interface between the PEM and AEM as the WD catalysts. The standard potential required to drive WD is 0.83 V (Oener, S. Z., Foster, M. J. & Boettcher, S. W. Accelerating water dissociation in bipolar membranes and for electrocatalysis. Science 369, 1099-1103, (2020); Tufa, R. A. et al. Bipolar Membrane and Interface Materials for Electrochemical Energy Systems. ACS Applied Energy Materials 4, 7419-7439, (2021)), above which the WD current increases exponentially until reaching the mass transport limit. The WD polarization curves reveal that the pure BPM with no catalyst, with the naked Ptₜₑₜ core or with crystalline Ni(OH)₂ nanoplates require an overpotential of 1.64 V, 0.97 V, and 0.64 V, respectively, to reach the 50 mA/cm², while that with the amorphous Ni(OH)₂ shell (in Ptₜₑₜ@Ni(OH)₂) only needs 0.18 V overpotential to reach 50 mA/cm², demonstrating a much faster WD kinetics, and experimentally confirming the exceptional WD catalytic activity of the amorphous Ni(OH)₂.

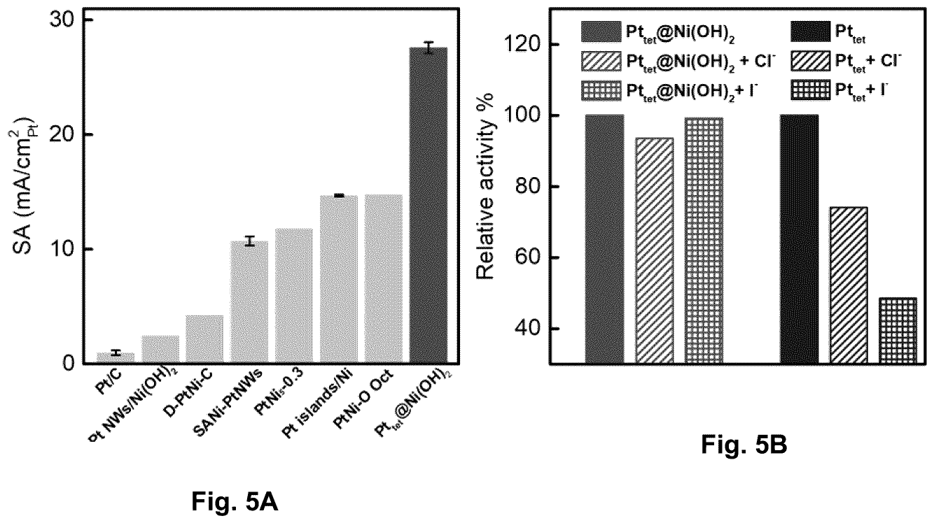

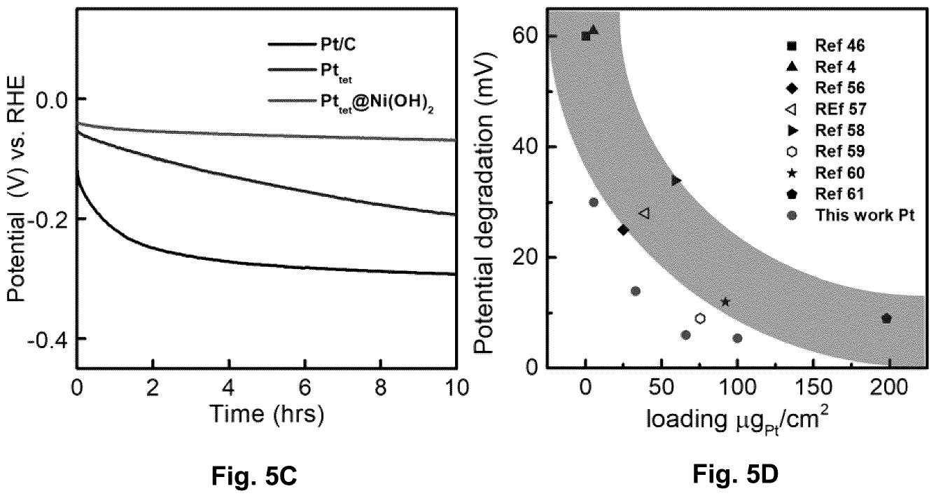

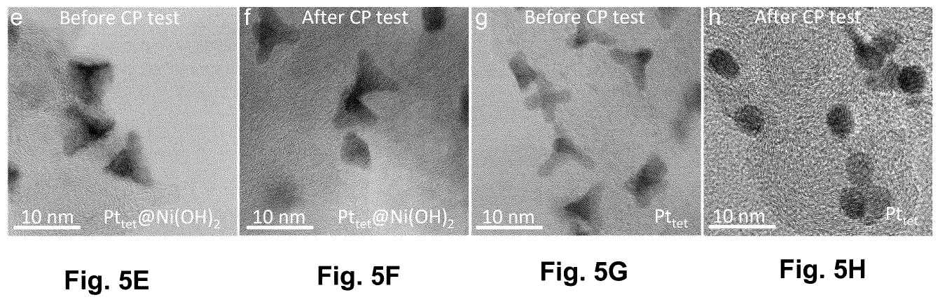

FIGS. 5A to 5H illustrate example evaluations of HER activity and stability of Ptₜₑₜ@Ni(OH)₂ according to embodiments For example, FIG. 5A is a graphical comparison of the specific activity (SA) of Ptₜₑₜ@Ni(OH)₂ with the state-of-the-art alkaline HER catalysts. FIG. 5B is a graph illustrating relative activity of Ptₜₑₜ@Ni(OH)₂ and Ptₜₑₜ in pure 1.0 M KOH, 1.0 M KOH⁺ 0.5 M Cl⁻, and 1.0 M KOH⁺ 0.25 M I⁻. FIG. 5C is a graph illustrating results of a chronopotentiometry (CP) stability test of Ptₜₑₜ@Ni(OH)₂, Ptₜₑₜ, and Pt/C. FIG. 5D is a graph providing a comparison of the stability of Ptₜₑₜ@Ni(OH)₂ with different loading with the state-of-the-art alkaline HER catalysts. It should be noted that there are numerous parameters in the stability tests, including Pt loading amount, current density, operation time, etc. It is extremely difficult to have all the parameters identical when compared with the literature data. Here specifically selected were the stability results from the literature which conduct the CP test with a fixed current density at 10 mA/cm² and duration longer than 10 hours. Only the potential degradation data within the first 10 hours are taken into consideration. FIGS. 5E to 5H are representative HRTEM images of Ptₜₑₜ@Ni(OH)₂ and Ptₜₑₜ before and after the stability tests.

More particularly, as shown in FIG. 5A, with greatly improved HER kinetics from the selective enrichment of proton by the Ni(OH)₂ proton sieve, the Ptₜₑₜ@Ni(OH)₂ coreshell catalysts show a record-high specific activity (SA) of 27.7 mA/cm² Pt at −70 mV vs. RHE at pH 14, which is 28 times and 6 times that of Pt/C and naked Ptₜₑₜ, respectively; and considerably higher than the previous state-of-art (14.8 mA/cm² Pt@ −70 mV vs. RHE) as shown in FIG. 5A (Zhang, C. et al. H₂ In Situ Inducing Strategy on Pt Surface Segregation Over Low Pt Doped PtNi₅ Nanoalloy with Superhigh Alkaline HER Activity. Advanced Functional Materials 31, 2008298, (2021)). It is noted the SA achieved with Ptₜₑₜ@Ni(OH)₂ is also higher than that of the recently reported Pt-shell catalysts with elaborate strain engineering on Pd nanocubes (He, T. et al. Mastering the surface strain of platinum catalysts for efficient electrocatalysis. Nature 598, 76-81, (2021)). Further, since the Ni(OH)₂ shell only moderately reduces the ECSA, such a high SA observed in Ptₜₑₜ@Ni(OH)₂ has also directly led to a record-high MA of 13.4 A/mg Pt @ −70 mV vs. RHE, which is 18-fold higher than that of the commercial Pt/C, and 4.6-fold of that of naked Ptₜₑₜ; and represent the best among the state-of-the-art Pt-based HER catalysts in the alkaline electrolyte (Table 6) (Zhou, K. L. et al. Platinum single-atom catalyst coupled with transition metal/metal oxide heterostructure for accelerating alkaline hydrogen evolution reaction. Nature Communications 12, 3783, (2021)). Additionally, considering the greatly reduced Tafel slope with the Ptₜₑₜ@Ni(OH)₂ design, the relative benefit of the increased SA and MA could be further amplified at higher overpotential in practical HER conditions.

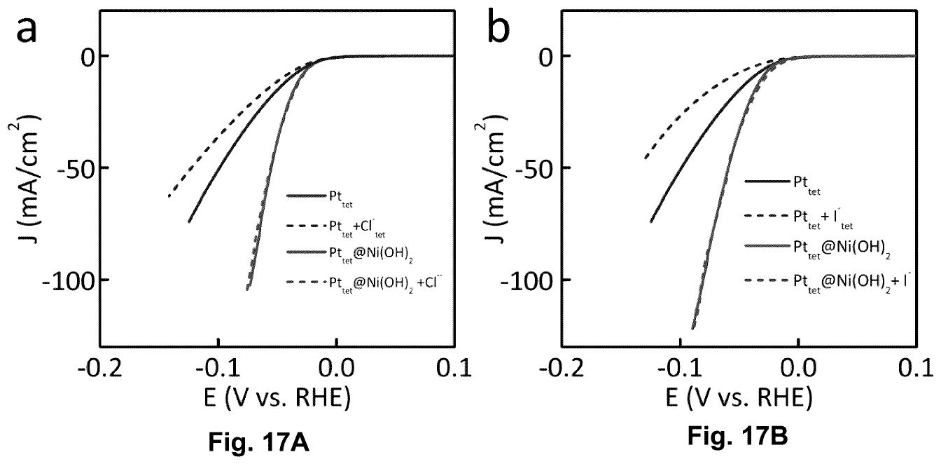

The proton conductive Ni(OH)₂ shell could help isolate the active Pt sites from the bulk electrolyte environment and thus improve the catalytic tolerance to water impurities with competitive adsorption or capability of etching. For example, halide anions (e.g., Cl⁻) represent common impurity anions that can strongly bind with Pt sites and partly suppress the catalytic activity. In this regard, the amorphous Ni(OH)₂ shell may help block halide anions from the active Pt sites due to the lack of transport path and Donnan exclusion effect (Sarkar, S., SenGupta, A. K. & Prakash, P. The Donnan Membrane Principle: Opportunities for Sustainable Engineered Processes and Materials. Environmental Science & Technology 44, 1161-1166, (2010)). To this end, evaluated was the Cl⁻ and I⁻ tolerance of the Ptₜₑₜ@Ni(OH)₂ and the naked Ptₜₑₜ catalysts. Notably, the Ptₜₑₜ@Ni(OH)₂ maintains essentially the same HER current level in the presence of 0.5 M Cl⁻ or 0.25 M I⁻ in electrolyte, while the Ptₜₑₜ shows a substantial current drop by 26% and 52%, respectively (see FIG. 5b and FIGS. 17A and 17B). Such a high tolerance to ionic impurities could help relax the water purity requirements in practical water electrolysis, which is a largely unaddressed matter but could be significant since the cost of ultrapure water and the relevant circulation system constitutes a significant fraction (up to 13%) of the total hydrogen production cost (Mayyas, A. T., Ruth, M. F., Pivovar, B. S., Bender, G. & Wipke, K. B. Manufacturing Cost Analysis for Proton Exchange Membrane Water Electrolyzers. Medium: ED; Size: 3.3 MB (United States, 2019)).

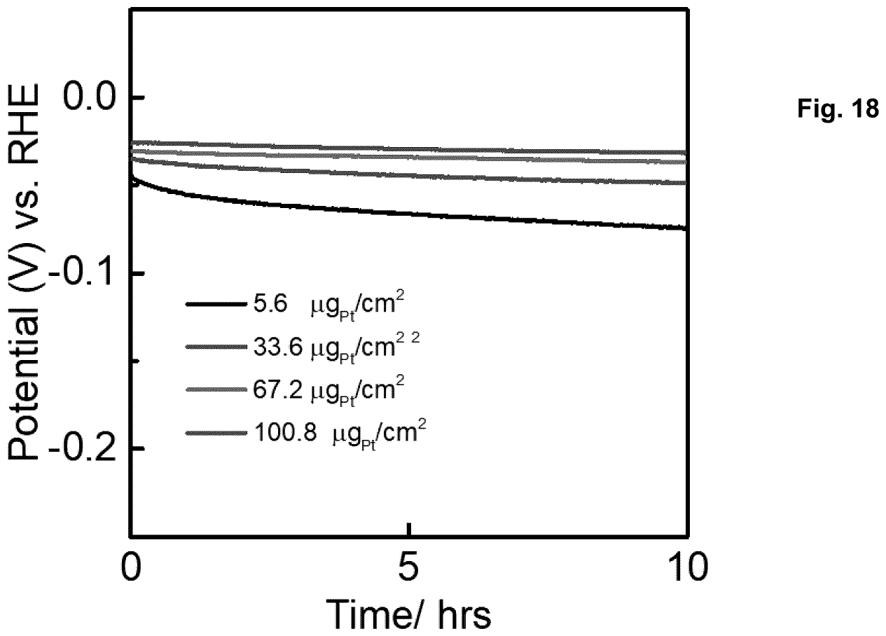

Additionally, the Ni(OH)₂ encapsulation can also prevent the Pt surface from dissolution, leaching, ripening, or aggregation. Chronopotentiometry (CP) tests were conducted to evaluate the durability of the Pttₑₜ@Ni(OH)₂ catalysts at a constant current of 10 mA/cm² (normalized by electrode geometrical area). These CP studies show that Ptₜₑₜ@Ni(OH)₂ coreshell catalysts exhibit only a 30 mV overpotential increase over the 10-hour continuous test as shown in FIG. 5C, much lower than those of naked Ptₜₑₜ and Pt/C under the same test conditions (140.5 mV and 177 mV potential degradation in 10 hours, respectively). It is noted that such CP test evaluation of HER catalyst durability is highly dependent on the catalyst loading amount. To more comprehensively compare the stability of the present Ptₜₑₜ@Ni(OH)₂ catalysts with other Pt HER catalysts under similar operation conditions, plotted was the potential degradation vs. the loading amount of different catalysts reported in recent literature (see FIG. 5D and FIG. 18) (Zhang, H. et al. Open hollow Co—Pt clusters embedded in carbon nanoflake arrays for highly efficient alkaline water splitting. Journal of Materials Chemistry A 6, 20214-20223, (2018); Xing, Z., Han, C., Wang, D., Li, Q. & Yang, X. Ultrafine Pt Nanoparticle-Decorated Co(OH)₂ Nanosheet Arrays with Enhanced Catalytic Activity toward Hydrogen Evolution. ACS Catalysis 7, 7131-7135, (2017); Song, H. J., Sung, M.-C., Yoon, H., Ju, B. & Kim, D.-W. Ultrafine α-Phase Molybdenum Carbide Decorated with Platinum Nanoparticles for Efficient Hydrogen Production in Acidic and Alkaline Media. Advanced Science 6, 1802135, (2019); Xie, L. et al. A Ni(OH)₂—PtO₂ hybrid nanosheet array with ultralow Pt loading toward efficient and durable alkaline hydrogen evolution. Journal of Materials Chemistry A 6, 1967-1970, (2018); Zhao, W. et al. Key Single-Atom Electrocatalysis in Metal-Organic Framework (MOF)-Derived Bifunctional Catalysts. ChemSusChem 11, 3473-3479, (2018); Jang, S. W. et al. Holey Pt Nanosheets on NiFe-Hydroxide Laminates: Synergistically Enhanced Electrocatalytic 2D Interface toward Hydrogen Evolution Reaction. ACS Nano 14, 10578-10588, (2020)).

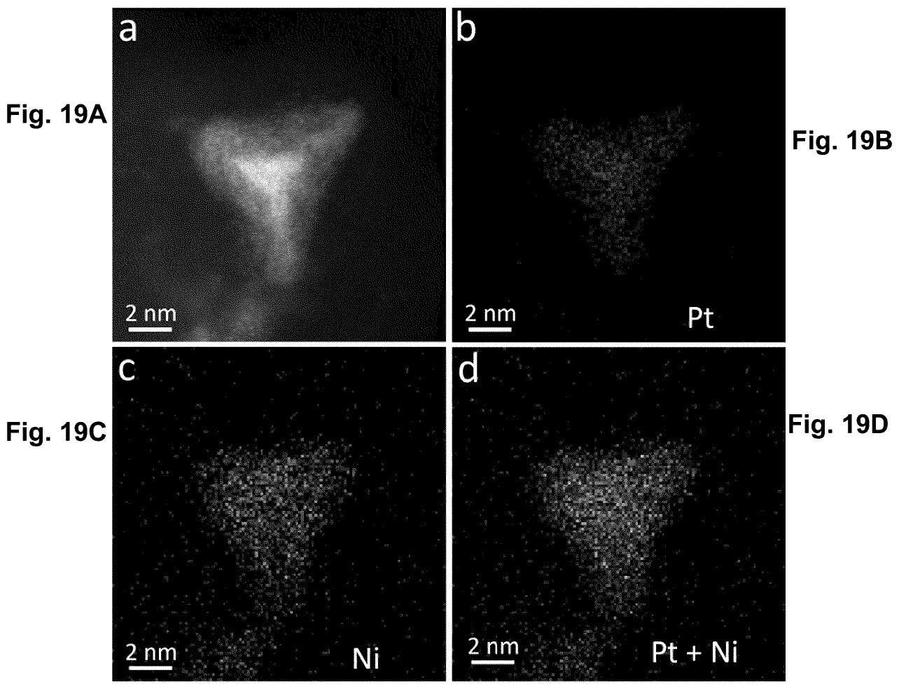

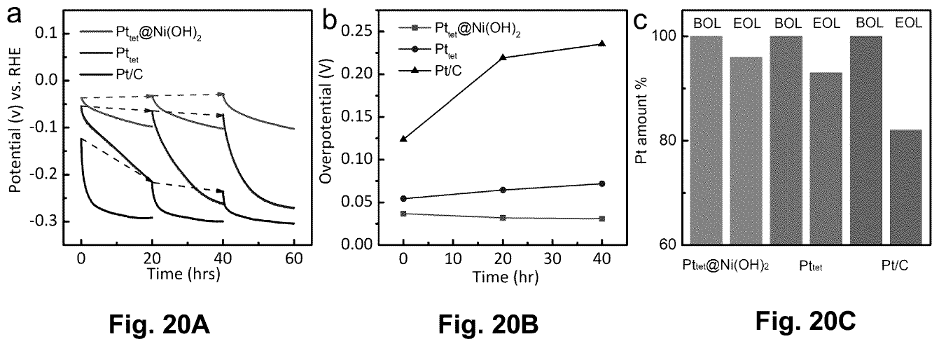

It is apparent that the potential degradation decreases substantially with the increasing Pt loading. This is not surprising since higher loading usually comes with more active surface sites, which reduces the average catalytic current per active site and thus reduces the chemical stress or slows the surface degradation process. Indeed, the present Ptₜₑₜ@Ni(OH)₂ catalysts with four different loading amounts show a similar trend with a notably smaller potential degradation at the higher catalyst loading levels (see FIG. 5D and FIG. 18). More importantly, the potential degradation of Ptₜₑₜ@Ni(OH)₂ catalysts is considerably below the reference curve, demonstrating the more stable nature of the Ptₜₑₜ@Ni(OH)₂ coreshell catalysts. In general, the Pt nanocatalysts typically feature a relatively high surface energy, and may readily undergo surface reconstruction or ripening process to minimize the total surface energy (McCrum, I. T., Hickner, M. A. & Janik, M. J. First-Principles Calculation of Pt Surface Energies in an Electrochemical Environment: Thermodynamic Driving Forces for Surface Faceting and Nanoparticle Reconstruction. Langmuir 33, 7043-7052, (2017)), particularly under HER conditions where the dynamic interaction with surface bonded H atoms (Pt—H) was found to considerably accelerate surface Pt atom diffusion (Horch, S. et al. Enhancement of surface self-diffusion of platinum atoms by adsorbed hydrogen. Nature 398, 134-136, (1999)). Such surface reconstruction or ripening process could lead to the loss of originally designed surface structure and the irreversible activity degradation. In this regard, the encapsulation by the proton conductive Ni(OH)₂ shell can effectively retards Pt surface atom migration in Ptₜₑₜ@Ni(OH)₂ to ensure high structural stability and durable activity. Indeed, FIGS. 5E and 5F demonstrate that the tetrahedral shape of Ptₜₑₜ@Ni(OH)₂ and the embedded Pt tetrapods are well-retained (see FIGS. 19A to 19D) with little Pt loss after the long-term durability test. In contrast, as shown in FIGS. 5G and 5H, the naked Ptₜₑₜ without Ni(OH)₂ shell undergoes severe ripening with higher Pt loss during the stability test and turns into nearly spherical nanoparticles. Additional stability tests with periodic surface cleaning reveal that the activity loss observed in Ptₜₑₜ@Ni(OH)₂ can be largely recovered after surface cleaning, indicating little irreversible catalyst degradation, which is consistent with the well-retained core-shell morphology. On the other hand, the Ptₜₑₜ and Pt/C show considerable irreversible degradation due to the severe surface reconstruction and ripening behavior (see FIGS. 20A to 20C).

In summary, the present embodiments relate to a unique design of “Ni(OH)₂-clothed Pt-tetrapod” core-shell nanostructure, in which the amorphous Ni(OH)₂ shell functions as a water dissociation catalyst and proton conductive shell to isolate the catalytic Pt surface from the bulk alkaline electrolyte while ensuring efficient proton supply to Pt sites. It delivers an acidic-like HER kinetics in bulk alkaline electrolyte, with the lowest Tafel slope and the highest alkaline HER activity among all Pt-based catalysts reported to date. Moreover, the encapsulation of the catalytic surface by the proton conductive shell considerably slows the dissolution/diffusion of Pt atoms from catalytic surfaces and suppresses the undesirable poisoning effect from impurity ions, thus ensuring high structural stability and activity durability that is difficult to achieve in the naked Pt-catalyst designs. The markedly improved alkaline HER activity and presents an attractive catalyst material for alkaline water electrolyzers and renewable chemical fuel generation. Additionally, the demonstrated capability to fundamentally modify the reaction kinetics by tailoring the local chemical environment may be expanded as a general strategy for the design of a new generation of electrocatalysts with a favorable reaction environment and high selectivity or durability for a wide range of fundamentally and technologically important electrochemical reactions.

### Example Methods

Chemicals. Platinum(II) acetylacetonate [Pt(acac)₂, Pt 48.0%], nickel(II) acetylacetonate [Ni(acac)₂, 95%], glucose, tungsten(0) hexacarbonyl (W(CO)₆, 97%), oleylamine (>98%), 1-octadecene (ODE, >90%), nickel(II) nitrate hexahydrate [Ni(NO₃)₂·6H₂O], Cetrimonium bromide ([(C₁₆H₃₃)N(CH₃)₃]Br and Nafion® 117 solution (˜5%) were purchased from Sigma Aldrich. Commercial Pt/C catalyst (10 wt % Pt, and particle size ˜2 nm) was purchased from Alfa Aesar. Ethanol (200 proof) was obtained from Decon Labs, Inc. Potassium hydroxide (KOH) was purchased from Fisher Chemical. All the above reagents were used as received without further purification. Carbon black (Vulcan XC-72) was received from Cabot Corporation and was annealed for 2 hours under Ar gas environment at 400° C. before being used. The deionized water (18 MΩ/cm) was obtained from an ultra-pure purification system (Milli-Q advantage A10). The Naftion™ 117 (PEM) and the Fumasep Fas-50 (AEM) were purchased from the Fuel cell Store.

Synthesis. In a 30 mL glass vial, 20 mg Pt(acac)₂, 25.6 mg Ni(acac)₂, 32 mg W(CO)₆ and 135 mg glucose were dissolved in a mixture of 3 mL oleylamine and 2 mL octadecene. The mixture was sonicated for 1 hour and the resulting homogenous solution was kept at 80° C. for 2.5 hours and then heated to 140° C. for another 8 hours. After the reaction, the precipitate was centrifuged out at 12100 r.p.m. and washed by ethanol/hexane (25 mL/5 mL) three times. The final product was suspended in 10 mL cyclohexane. In a 30 mL glass vial, 30 mg carbon black (the carbon black was annealed under Ar at 200° C. for 1 hour before use) was sonicated in 15 mL ethanol for 1 hour. 5 mL Ptₜₑₜ@Ni(OH)₂ hexane solution was then added into the carbon black/ethanol solution and the mixture was sonicated for another 1 hour. The catalysts were centrifuged out at 12100 r.p.m. and washed with cyclohexane/ethanol solution three times, followed by being dried in the vacuum oven for 1 hour. The Ptₜₑₜ@Ni(OH)₂/C were then annealed in the air at 200° C. for 2 hours to fully remove the surface remaining ligands. The Pt yield is about 40%, on the scale of 6 mgPt/batch. It has been scaled up to 120 mgPt per batch. The crystalline Ni(OH)₂ nanoplates were synthesized via adding 0.5 mL 30 wt % ammonia water drop by drop into 100 mL Ni(NO)₃ solution (10 g/L) with 0.25 g CTAB as the surfactant.

Characterizations. Transmission electron microscopy (TEM) images were taken on an FEI T12 operated at 120 kV. Atomic resolution high angle annular dark-field scanning transmission electron microscopy (HAADF-STEM) images and X-ray energy dispersive spectroscopy (EDS) mapping were taken on FEI Titan Cubed Themis G2 300 at 200 kV and JEOL Grand ARM 300CF TEM/STEM with double spherical aberration-correctors operated at 300 kV. Samples for TEM measurements were prepared by dropping 10-20 μL nanoparticles dispersion in hexane on a carbon-coated copper grid (Ladd Research, Williston, VT). Powder X-ray diffraction patterns (PXRD) were collected on a Panalytical X'Pert Pro X-ray Powder Diffractometer with Cu-Kα radiation. The composition of catalysts was determined by inductively coupled plasma atomic emission spectroscopy (ICP− AES, Shimadzu ICPE-9000) as well as SEM-EDS (JEOL JSM-6700F FE-SEM). X-ray photoelectron spectroscopy (XPS) tests were done with Kratos AXIS Ultra DLD spectrometer.

X-ray adsorption data analysis. Ni K-edge and Pt L3-edge X-ray absorption spectra were acquired under ambient conditions in fluorescence and transmission modes at beamline 1W2B of the Beijing Synchrotron Radiation Facility(BSRF), using a Si (111) double-crystal monochromator. The storage ring of BSRF was operated at 2.5 GeV with a maximum current of 250 mA in top-up mode. While the energy was calibrated using Ni/Pt foil, the incident, transmitted and fluorescent X-ray intensities were monitored by using standard ion chambers and Lytle-type detector, respectively.

XAS analysis was performed according to standard procedures using the ATHENA and ARTEMIS modules implemented in the IFEFFIT software package (Ravel, B. & Newville, M. ATHENA, ARTEMIS, HEPHAESTUS: data analysis for X-ray absorption spectroscopy using IFEFFIT. Journal of Synchrotron Radiation 12, 537-541, (2005)). The EXAFS signal was first obtained by background-subtraction and normalization, then the x(k) data were Fourier transformed to real (R) space using a Hanning window. To obtain the quantitative structural parameters around the central atoms, a least-squares curve-fitting analysis of the EXAFS χ(k) data was carried out based on the EXAFS equation in R-space. The structural models were constructed based on the crystal structures of Ni(OH)₂, with the scattering amplitudes, phase shifts, and photoelectron mean free path for all paths calculated with the ab initio code FEFF 8.5 (Rehr, J. J. & Albers, R. C. Theoretical approaches to x-ray absorption fine structure. Reviews of Modern Physics 72, 621-654, (2000)).

Electrochemical Measurements. To obtain a homogeneous catalyst ink, 1 mg of dried Ptₜₑₜ@Ni(OH)₂/C was mixed with 1 mL ethanol and sonicated for 5 minutes. Then, 10 μL (20 μL for stability test) of Nafion (5 wt %) was added to the solution. After sonication, 20 μL of the homogeneous ink was dropped onto a 5 mm diameter glassy carbon electrode (0.196 cm², Pine Research Instrumentation). The ink was dried under ambient air before electrochemical testing.

All electrochemical tests were carried out in a three-electrode cell from Pine Research Instrumentation. The working electrode was a glassy carbon rotating disk electrode (RDE) coated with corresponding catalysts. The reference electrode was a Hg/HgO electrode from CH Instrument and was calibrated in 1.0 M KOH with saturated H₂. A graphite rod was used as the counter electrode. Cyclic voltammetry was conducted in 1.0 M KOH and 1.0 M HClO₄ between 50 mV to 1100 mV vs. RHE at a sweep rate of 100 mV/s. The polarization curves were tested between −200 mV to 100 mV vs. RHE at a sweep rate of 5 mV/s in 1.0 M KOH and 1.0 M HClO4 with a Pt loading of 5.1 g/cm² for Pt/C and 5.6 μg/cm² for Ptₜₑₜ@Ni(OH)₂ and Ptₜₑₜ, under a rotation speed of 1600 r.p.m. The solution resistances were measured via impedance test. ECSA was measured through the hydrogen desorption region in N₂ saturated 1 M KOH. The bipolar membrane test was conducted in the H-cell. The BPM was fabricated by wet pressing the Nafion 117 PEM and the Fumasep Fas-30 AEM and removing all the bubbles in between two films. When desired, the WD catalysts were pre-deposited on the PEM and the press together with AEM to form BPM with sandwiched WD-CL. The stability test was performed with chronopotentiometry under 10 mA/cm² in Ar purged KOH for 10 hours.

TABLE 1
Comparison of the Tafel slope of Ptₜₑₜ@Ni(OH)₂
in this work with the state- of-the-art literature.

| | | Tafel slope | Pontential range | | | |
|---|---|---|---|---|---|---|
| | Material | (mV/dec) | (mV vs. RHE) | | Electrolyte | Ref |
| 1 | Ptₜₑₜ@Ni(OH)₂ | 25 | 10 to −20 | | 1.0M KOH | This |
| | Ptₜₑₜ | 40 | 10 to −20 | | | work ^{a} |
| | | 102 | −50 to −100 | | | |
| | Pt/C | 75 | −100 to −160 | | | |
| | | 183 | 0 to −50 | | | |
| 2 | PtNi—O | 40 | 10 to −20 | | 1.0M KOH | 4^{b} |
| 3 | SANi—Pt | 37 | 10 to −20 | | 1.0M KOH | 43^{b} |
| 4 | Ni₃N—Pt | 36.5 | 0 to −50 | mV | 1.0M KOH | 44 |
| | Pt/C | 50.6 | 0 to −50 | mV | | |
| 5 | Pt_{3.21}Ni@Ti₃C₂ | 38.5 | 20 to −20 | mV | 0.1M KOH | 45 |
| | Pt/C | 39.5 | 20 to −20 | mV | | |
| 6 | 1.9 nm Pt island | 69 | −10 to −20 | mV | 1.0M KOH | 46 |
| 7 | D-PtNi/C | 55 | −5 to −25 | mV | 1.0M KOH | 47 |
| | Pt/C | 56 | −5 to −25 | mV | | |
| 8 | NtS₂/PtNi NWs | 20 | −10 to −20 | mV | 0.1M HClO₄ | 48 |
| | | 38 | −10 to −20 | mV | 0.1M KOH | |

^{a}The Ptₜₑₜ@Ni(OH)₂ coreshell catalysts show a Tafel slope notably smaller than those of naked Ptₜₑₜ, commercial Pt/C, and all previously reported surface decorated Pt catalysts alkaline HER, demonstrating that this full encapsulation of Pt surface with proton permeable Ni(OH)₂ shell effectively isolates the Pt surface from the alkaline electrolyte and create a lower local pH on Pt surface, and thus fundamentally altering the HER pathway to acidic-like kinetics with the Tafel step limited pathway, achieving a much lower Tafel slope (<30 mV/dec) and much higher activity.
^{b}The Tafel slope is obtained from the recalculation from the original data in a different potential range compared with the value reported in the published version.

TABLE 2
Ni K-edge EXAFS curve fitting parameters.^{a}

| | | | | | ΔE₀ | R, |
|---|---|---|---|---|---|---|
| sample | path | N | R (Å) | σ² (Å²) | (eV) | % |
| Ni foil^{b} | Ni—Ni | 12 | 2.48 | 0.008 | 0.5 | 0.01 |
| Ni(OH)₂^{c} | Ni—O | 6 | 2.06 | 0.008 | −7.8 | 0.6 |
| | Ni—Ni | 6 | 3.11 | 0.008 | | |
| Ni—Ptₜₑₜ(OH)₂^{c} | Ni—O | 5.5 | 2.07 | 0.009 | 5.4 | 0.3 |
| | Ni—Ni | 5.0 | 3.05 | 0.010 | | |
| | Ni—Pt | 1.0 | 3.10 | 0.010 | | |

^{a}N, coordination number; R, the distance between absorber and backscatter atoms; 62, Debye-Waller factor to account for both thermal and structural disorders; AEO, inner potential correction; R factor (%) indicates the goodness of the fit. Error bounds (accuracies) that characterize the structural parameters obtained by EXAFS spectroscopy were estimated as N ± 20%; R ± 1%; σ² ± 20%; ΔE0 ± 20%. S₀² was determined from Ni foil fitting. Bold numbers indicate fixed coordination number (N) according to the crystal structure.
^{b}Fitting range: 3.2 ≤ k (/Å) ≤ 11.0 and 1.0 ≤ R (Å) ≤ 3.0.
^{c}Fitting range: 2.5 ≤ k (/Å) ≤ 10.4 and 1.0 ≤ R (Å) ≤ 3.4.

TABLE 3
Pt L3-edge EXAFS curve fitting parameters.^{a}

| | | | | | ΔE₀ | R, |
|---|---|---|---|---|---|---|
| sample | path | N | R (Å) | σ² (Å²) | (eV) | % |
| Pt foil^{b} | Pt—Pt | 12 | 2.76 | 0.004 | 6.8 | 0.01 |
| PtO₂^{c} | Pt—O1 | 6 | 2.02 | 0.005 | 4.2 | 0.02 |
| | Pt—Pt | 6 | 3.10 | 0.006 | | |
| | Pt—O2 | 12 | 3.70 | 0.010 | | |
| Pt—Ptₜₑₜ@Ni(OH)₂^{b} | Pt—Pt | 8.9 | 2.70 | 0.004 | 5.0 | 0.2 |
| | Pt—Ni | 2.0 | 3.12 | 0.005 | | |

^{a}N, coordination number; R, the distance between absorber and backscatter atoms; σ², Debye-Waller factor to account for both thermal and structural disorders; ΔE0, inner potential correction; R factor (%) indicates the goodness of the fit. Error bounds (accuracies) that characterize the structural parameters obtained by EXAFS spectroscopy were estimated as N ± 20%; R ± 1%; σ2 ± 20%; ΔE0 ± 20%. S02 was determined from Pt foil fitting and fixed. Bold numbers indicate fixed coordination number (N) according to the crystal structure.
^{b}Fitting range: 3.0 ≤ k (/Å) ≤ 11.0 and 1.2 ≤ R (Å) ≤ 3.2.
^{c}Fitting range: 3.0 ≤ k (/Å) ≤ 11.0 and 1.2 ≤ R (Å) ≤ 3.6.

Table 4—Comparison of the coordination number and bond length fitted from EXAFS and simulated NiOₓH_{y} model. Our model is in good accordance with the experimental results and further confirms the accuracy and the robustness of the following simulation results based on this model. The slight deviation of coordination number (N) should be ascribed to much smaller numbers of atoms of the modeled motif compared with the real structure.

| Sample | Path | N_{XANES} | N_{theory} | R_{XANES} (Å) | R_{theory} (Å) |
|---|---|---|---|---|---|
| Pt@NixOy | Ni—O | 5.50 | 5.17 | 2.07 | 2.08 |
| | Ni—Ni | 5.00 | 4.50 | 3.05 | 3.04 |
| | Ni—Pt | 1.00 | 2.17 | 3.10 | 3.10 |
| | Pt—Pt | 8.90 | 8.00 | 2.70 | 2.80 |
| | Pt—Ni | 2.00 | 1.67 | 3.12 | 3.14 |

TABLE 5
| ΔG_{H}_{^{O}} of the Pt(111) fcc and atop, and Pt@NiₓO_{y}.

| Sample | ΔG_{H} [symbol] | ΔG_{H} (pH 0) | ΔG_{H}(pH 14) |
|---|---|---|---|
| Pt(111) fcc | −0.09 eV | −0.09 eV | 0.74 eV |
| Pt(111) atop | −0.26 eV | −0.26 eV | 0.57 eV |
| Pt@NixOy atop | −0.14 eV | −0.14 eV | 0.69 eV |
| | | | −0.04-0.41 eV |
| | | | (proton supply |
| | | | rate corrected) |

[symbol]

indicates data missing or illegible when filed

TABLE 6
Comparison of HER performance of the Ptₜₑₜ@Ni(OH)₂ in this work
with state- of-the-art catalysts. Mass activity (normalized by Pt loading)
and specific activity (normalized by ECSA) were compared.^{a}

| | Mass activity | Specific activity | ECSA | |
|---|---|---|---|---|
| | at −70 mV vs. | at −70 mV vs. | (m²/g) in | |
| Catalysts | RHE (mA/μg_{Pt}) | RHE (mA/cm [symbol] ) | 1M KOH | Reference |
| Pt/C | 0.75 | 0.98 | 76.4 | This work |
| Ptₜₑₜ@Ni(OH)₂ | 13.4 | 27.7 | 48.4 | This work |
| SANi-JPtNWs | 11.8 | 10.7 | 106 | 43 |
| PtNiO octahedra | 7.23 | 14.8 | 48.8 | 4 |
| Pt NWs/ | 0.679 | 2.48 | 27.3 | 3 |
| SL-Ni(OH)₂ | | | | |
| NiOₓ/Pt₃Ni | 2.59 | NA | NA | 18^{b} |
| Pt₃Ni₃—NWs | | | | |
| Pt₃Ni₂—NWs/S C | 2.48 | NA | NA | 17^{b} |
| Pt_{3.6}Ni—S NWs | 4.37 | NA | NA | 6 |
| D-PtNi/C | 1.03 | 4.26 | 24.2 | 47 |
| 1.9 nm Pt-island | 7.7 | 14.7 | 52 | 46^{c} |
| on Ni | | | | |
| PtNi5-0.3 | 2.36 | 11.8 | 20 | 51 |
| Pt SAs—Ni/NiO | ~10.7 | NA | NA | 53^{b} |

^{a}Generally, overpotential, mass activity, and specific activity are three major descriptors when comparing the Pt catalysts' HER performance. However, the overpotential largely depends on the Pt-loading which varies substantially among literature, making it difficult to use overpotential as the activity descriptor without considering the Pt-loading. To alleviate the effect of Pt-loading, it is more appropriate to use the mass activity at certain overpotential (e.g. −70 mV vs. RHE) or the overpotential achieved at a given current density normalized by ECSA for comparing the practical HER activity of different noble metal catalysts in literature.
Additionally, specific activity can provide a better description of the intrinsic HER activity of a given catalyst surface.
^{b}In these cases, the mass activity values were recalculated based on the reported mass loading and the electrode geometric surface area normalized HER polarization curve provided in the literature.
^{c}The electrochemistry characterizations are conducted in 0.1M KOH in these cases, otherwise in 1M KOH if not specified. [symbol]
indicates data missing or illegible when filed

Amorphous nickel hydroxide proton sieve tailors local chemical environment on Pt surface for high-performance alkaline hydrogen evolution reaction

### Notes

1. The estimation of H⁺ diffusion distance: The OH⁻ concentration in the pH 14 electrolyte is 1 mol/L, which equals 1 OH⁻ in 1.66 nm³. An H⁺ generated from the dissociation of an H₂O molecule on the Ni species can only diffuse away for about 1.18 nm (the cubic root of 1.66 nm³) before encountering and reassociating with another OH⁻ from the bulk alkaline electrolyte. Based on this consideration, the diffusion distance of a free hydronium (H₃O+) is estimated to be around 1.18 nm. This simple estimate suggests that on the Pt surface that is partially decorated with crystalline Ni species, only a small fraction of Pt atoms that are located within 1.18 nm from the Ni species can benefit from the enhanced water dissociation.

2. Tafel slope extraction: The quantification and comparison of the Tafel slope is a nontrivial matter and requires extra caution to ensure a fair and consistent comparison. There are two commonly used methods to extract the Tafel slope from the HER polarization curve: (1) Butler-Volmer (B-V) fitting of the HER/HOR kinetic current in the H₂ purged electrolyte; (2) linear fitting of the overpotential vs. logarithm of the HER kinetic current in the N₂ purged electrolyte. Both methods have been used in different literature. For the B—V fitting of Pt HER/HOR kinetic current under the H₂ purge, there are three possible ideal models depending on the exact rds:
i) Volmer (rds)-Tafel pathway, with the cathodic HER current

$${i}_{c} = {i}_{0} \times ( - {e}^{- \frac{α F}{RT} η} )$$

and the cathodic HOR current

$${i}_{a} = {i}_{0} \times ( {e}^{\frac{β F}{RT} η} ) ; \qquad ( FIG . 21 A )$$

ii) Volmer (rds)-Heyrovsky pathway, with the cathodic HER current

$${i}_{c} = {i}_{0} \times ( - {e}^{- \frac{α F}{RT} η} )$$

an the odic HOR current

$${i}_{c} = {i}_{0} \times ( {e}^{\frac{( 1 + β ) F}{RT} η} ) ; \qquad ( FIG . 21 B )$$

iii) Volmer-Heyrovsky(rds) pathways, with the cathodic HER current

$${i}_{c} = {i}_{0} \times ( - {e}^{\frac{( 1 + α ) F}{RT} η} )$$

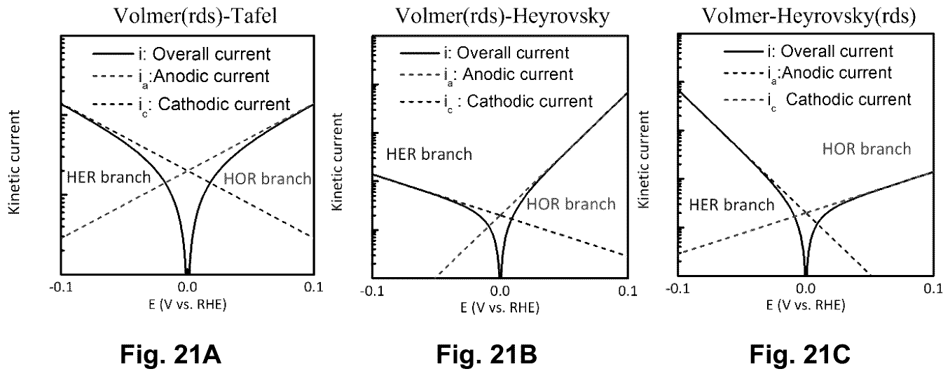

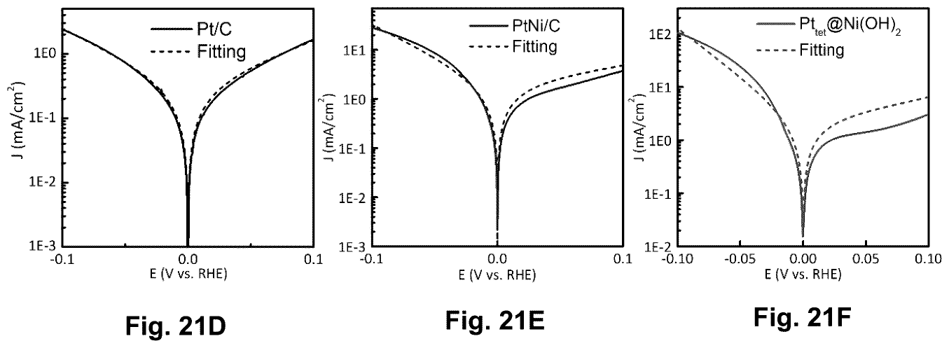

and the anodic HOR current

$${i}_{c} = {i}_{0} \times ( {e}^{\frac{β F}{RT} η} ) ; \qquad ( FIG . 21 C )$$

where i0 is the exchange current density, α ana β are the symmetric factors) and are set to 0.5, R is the molar gas constant, T is the temperature and η is the potential. Through extensive studies with different types of HER catalysts, it was found that the B—V fitting only works well for Pt/C with a moderate alkaline HER activity and standard Volmer (rds)-Tafel mechanism (see FIGS. 21C and 21D), while there are a number of critical issues in applying B—V fitting to the PtNi-based catalysts such as PtNi/C and the Ptₜₑₜ@Ni(OH)₂ (see FIGS. 21E and 21F). Specifically, Pt/C typically shows symmetric HER/HOR branches, and the kinetic current (ik) can be well fitted with the B—V equation with an a value close to 0.5 in 1 M KOH (see FIG. 21A). On the other hand, for PtNi/C and Ptₜₑₜ@Ni(OH)₂, due to the existence of surface Ni species, the HER rates are considerably enhanced while the HOR shows an abnormal passivation region at around 10-50 mV vs. RHE (see FIGS. 21E, 21F), leading to highly asymmetric HER/HOR branches that deviate from the standard expression of HER/HOR kinetics current. It is hypothesized that the surface Ni(OH)₂ plays a different role in determining the activation energy for HER and HOR, and thus reduces their reversibility. As a result, the ik cannot be reliably fitted with the B—V equation (see FIGS. 21E, 21F), and an attempted fitting could lead to unphysical α and β values (e.g., α>1, or α+β≠1), making it unreliable to derive or compare the Tafel slope. Additionally, it is noted there are also no strict rules for selecting the proper potential window when applying the B—V fitting. More active catalysts could reach mass transfer limitation at a lower overpotential, leading to a much smaller potential window that can be used for B—V fitting and thus higher uncertainty in the fitting results. Ptₜₑₜ@Ni(OH)₂ is clearly the case here due to its high activity.

Due to the above challenges associated with B—V fitting under H₂ purge, it has been chosen to use the linear fitting of the N₂ purged HER curve, which has been widely used by other literature (e.g. Ledezma-Yanez, I. et al. Interfacial water reorganization as a pH-dependent descriptor of the hydrogen evolution rate on platinum electrodes. Nature Energy 2, 17031 (2017); Monteiro, M. C. O., Goyal, A., Moerland, P. & Koper, M. T. M. Understanding Cation Trends for Hydrogen Evolution on Platinum and Gold Electrodes in Alkaline Media. ACS Catalysis 11, 14328-14335 (2021)) to extract the Tafel slope for the following reasons: (i) Under the N₂ purging and high rotating speed (1600 r.p.m.), the HOR branch is removed and thus linear fitting near the onset overpotential is not significantly affected by the HOR signal. There is a clearly linear region in the Tafel plot where the Tafel slope can be extracted. (ii) The Tafel slopes of different catalysts were extracted at similar current densities to ensure a similar mass transfer effect.

Lastly, it is recognized there could be some level of uncertainties associated with the Tafel slope derivations. Nonetheless, a careful analysis reveals a substantially lower Tafel slope (27 mV/decade) is achieved in Ptₜₑₜ@Ni(OH)₂ in the alkaline electrolyte when compared with all other references (>36 mV/decade), which is fully validated by internal control samples tested and evaluated with the exactly the same method. The difference is clearly beyond derivation uncertainties. Furthermore, it is important to note that the present materials also deliver a record-high specific activity and a record-high mass activity, which is a directly measured number with less ambiguity. Together, comprehensive evaluation and analysis robustly demonstrated that the present design has enabled a superior HER catalyst in the alkaline electrolyte.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent. Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. An apparatus for a unique core-shell structure (A@BOxHy) comprising:
a core comprising A; and
an amorphous or nanoporous shell structure (BOxHy) that is configured to enhance reaction kinetics and allow selective transport of certain feedstock while protecting catalysts in the core from competitive adsorption and morphology degradation.

2. The apparatus of claim 1, wherein the shell comprises amorphous hydrated oxides/hydroxides and the metal core comprises a precious metal.

3. The apparatus of claim 1, wherein B is one or more of Fe, Co, Ni, Ru, Rh, and Si.

4. The apparatus of claim 2, wherein B is one or more of Fe, Co, Ni, Ru, Rh, and Si.

5. The apparatus of claim 1, wherein A is Pt.

6. The apparatus of claim 3, wherein A is Pt.

7. The apparatus of claim 1, wherein the composition and structure of the shell is tuned for hydrogen transport rate through the shell.

8. The apparatus of claim 7, wherein tuning includes tailoring the local equilibrium pH at the surface of the core catalysts, leading to the desired proton concentration for pH-sensitive reactions including CO₂ RR or NRR.

9. The apparatus of claim 1, wherein the core and shell structure together comprise a Ni(OH)₂-clothed bare-foot Pt-tetrapod core/shell nanostructure [Ptₜₑₜ@Ni(OH)₂].

10. The apparatus of claim 9, wherein the Ptₜₑₜ@Ni(OH)₂ nanostructure comprises a Pt nano-tetrapod (Ptₜₑₜ) core as the HER catalyst and an amorphous Ni(OH)₂ shell as the water dissociation (WD) catalysts and proton permselective encapsulation.

11. The apparatus of claim 10, wherein a hydrogen-bond framework in the amorphous Ni(OH)₂ shell stabilizes the intermediate state of the WD step and facilitates water dissociation into OH⁻ and H⁺, with OH⁻ diffusing into the alkaline electrolyte and the H⁺ efficiently transporting to the Ptₜₑₜ core through the amorphous Ni(OH)₂ shell following a barrierless cascade pathway.

12. The apparatus of claim 10, wherein the encapsulation by the amorphous Ni(OH)₂ shell efficiently rejects water impurity ions.

13. The apparatus of claim 12, wherein the water impurity ions include Cl⁻ and I⁻.

14. The apparatus of claim 10, wherein the encapsulation by the amorphous Ni(OH)₂ shell efficiently suppresses Pt atom leaching.
